(19) United States
(12) Patent Application Publication
(10) Pub. No.: US 2024/0283507 A1
(43) Pub. Date: Aug. 22, 2024

(54) TECHNIQUES FOR CHANNEL STATE INFORMATION FEEDBACK FRAMEWORK ENHANCEMENTS FOR ADAPTATION OF SPATIAL ELEMENTS

(71) Applicant: QUALCOMM Incorporated, San Diego, CA (US)

(72) Inventors: Hung Dinh LY, San Diego, CA (US); Yu ZHANG, San Diego, CA (US); Lei XIAO, San Jose, CA (US)

(21) Appl. No.: 18/399,046

(22) Filed: Dec. 28, 2023

Related U.S. Application Data
(60) Provisional application No. 63/485,836, filed on Feb. 17, 2023.

(51) Int. Cl. H04B 7/06; H04B 7/0456; H04L 1/1607

(52) U.S. Cl. CPC H04B 7/0626; H04B 7/0482; H04L 1/1614

(57) ABSTRACT

Various aspects of the present disclosure generally relate to wireless communication. In some aspects, a user equipment (UE) may receive a pattern table indication for spatial element adaptation associated with at least one channel state information reference signal (CSI-RS) pattern table of a plurality of CSI-RS pattern tables, each CSI-RS pattern table of the plurality of CSI-RS pattern tables indicating a respective set of CSI-RS resource patterns. The UE may receive a pattern indication associated with an CSI-RS resource pattern indicated by the at least one CSI-RS pattern table. The UE may receive at least one CSI-RS based on the CSI-RS resource pattern. Numerous other aspects are described.

### CROSS-REFERENCE TO RELATED APPLICATION

This Patent application claims priority to U.S. Provisional Patent Application No. 63/485,836, filed on Feb. 17, 2023, entitled “TECHNIQUES FOR CHANNEL STATE INFORMATION FEEDBACK FRAMEWORK ENHANCEMENTS FOR ADAPTATION OF SPATIAL ELEMENTS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for channel state information feedback framework enhancements for adaptation of spatial elements.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a user equipment (UE) for wireless communication. The user equipment may include one or more memories and one or more processors coupled to the one or more memories. The one or more processors may be individually or collectively configured to receive a pattern table indication for spatial element adaptation associated with at least one channel state information reference signal (CSI-RS) pattern table of a plurality of CSI-RS pattern tables, each CSI-RS pattern table of the plurality of CSI-RS pattern tables indicating a respective set of CSI-RS resource patterns. The one or more processors may be configured to receive a pattern indication associated with an CSI-RS resource pattern indicated by the at least one CSI-RS pattern table. The one or more processors may be configured to receive at least one CSI-RS based on the CSI-RS resource pattern and to compute channel state information (CSI) based at least on the at least one CSI-RS.

Some aspects described herein relate to a network node for wireless communication. The network node may include one or more memories and one or more processors coupled to the one or more memories. The one or more processors may be individually or collectively configured to transmit a pattern table indication for spatial element adaptation associated with at least one CSI-RS pattern table of a plurality of CSI-RS pattern tables, each CSI-RS pattern table of the plurality of CSI-RS pattern tables indicating a respective set of CSI-RS resource patterns. The one or more processors may be configured to transmit a pattern indication associated with an CSI-RS resource pattern indicated by the at least one CSI-RS pattern table. The one or more processors may be configured to transmit at least one CSI-RS based on the CSI-RS resource pattern.

Some aspects described herein relate to a UE for wireless communication. The user equipment may include one or more memories and one or more processors coupled to the one or more memories. The one or more processors may be individually or collectively configured to receive a reduced antenna port indication for spatial element adaptation associated with at least one reduced CSI-RS antenna port configuration. The one or more processors may be configured to receive at least one CSI-RS based on the at least one reduced CSI-RS antenna port configuration and to compute CSI based at least on the at least one CSI-RS.

Some aspects described herein relate to a network node for wireless communication. The network node may include one or more memories and one or more processors coupled to the one or more memories. The one or more processors may be individually or collectively configured to transmit a reduced antenna port indication for spatial element adaptation associated with at least one reduced CSI-RS antenna port configuration. The one or more processors may be configured to transmit at least one CSI-RS based on the at least one reduced CSI-RS antenna port configuration.

Some aspects described herein relate to a method of wireless communication performed by a UE. The method may include receiving a pattern table indication for spatial element adaptation associated with at least one CSI-RS pattern table of a plurality of CSI-RS pattern tables, each CSI-RS pattern table of the plurality of CSI-RS pattern tables indicating a respective set of CSI-RS resource patterns. The method may include receiving a pattern indication associated with an CSI-RS resource pattern indicated by the at least one CSI-RS pattern table. The method may include receiving at least one CSI-RS based on the CSI-RS resource pattern and computing CSI based at least on the at least one CSI-RS.

Some aspects described herein relate to a method of wireless communication performed by a network node. The method may include transmitting a pattern table indication for spatial element adaptation associated with at least one CSI-RS pattern table of a plurality of CSI-RS pattern tables, each CSI-RS pattern table of the plurality of CSI-RS pattern tables indicating a respective set of CSI-RS resource patterns. The method may include transmitting a pattern indication associated with an CSI-RS resource pattern indicated by the at least one CSI-RS pattern table. The method may include transmitting at least one CSI-RS based on the CSI-RS resource pattern.

Some aspects described herein relate to a method of wireless communication performed by a UE. The method may include receiving a reduced antenna port indication for spatial element adaptation associated with at least one reduced CSI-RS antenna port configuration. The method may include receiving at least one CSI-RS based on the at least one reduced CSI-RS antenna port configuration and computing CSI based at least on the at least one CSI-RS.

Some aspects described herein relate to a method of wireless communication performed by a network node. The method may include transmitting a reduced antenna port indication for spatial element adaptation associated with at least one reduced CSI-RS antenna port configuration. The method may include transmitting at least one CSI-RS based on the at least one reduced CSI-RS antenna port configuration.

Some aspects described herein relate to a non-transitory computer-readable medium that stores a set of instructions for wireless communication by a UE. The set of instructions, when executed by one or more processors of the UE, may cause the UE to receive a pattern table indication for spatial element adaptation associated with at least one CSI-RS pattern table of a plurality of CSI-RS pattern tables, each CSI-RS pattern table of the plurality of CSI-RS pattern tables indicating a respective set of CSI-RS resource patterns. The set of instructions, when executed by one or more processors of the UE, may cause the UE to receive a pattern indication associated with an CSI-RS resource pattern indicated by the at least one CSI-RS pattern table. The set of instructions, when executed by one or more processors of the UE, may cause the UE to receive at least one CSI-RS based on the CSI-RS resource pattern and to compute CSI based at least on the at least one CSI-RS.

Some aspects described herein relate to a non-transitory computer-readable medium that stores a set of instructions for wireless communication by a network node. The set of instructions, when executed by one or more processors of the network node, may cause the network node to transmit a pattern table indication for spatial element adaptation associated with at least one CSI-RS pattern table of a plurality of CSI-RS pattern tables, each CSI-RS pattern table of the plurality of CSI-RS pattern tables indicating a respective set of CSI-RS resource patterns. The set of instructions, when executed by one or more processors of the network node, may cause the network node to transmit a pattern indication associated with an CSI-RS resource pattern indicated by the at least one CSI-RS pattern table. The set of instructions, when executed by one or more processors of the network node, may cause the network node to transmit at least one CSI-RS based on the CSI-RS resource pattern.

Some aspects described herein relate to a non-transitory computer-readable medium that stores a set of instructions for wireless communication by an UE. The set of instructions, when executed by one or more processors of the UE, may cause the UE to receive a reduced antenna port indication for spatial element adaptation associated with at least one reduced CSI-RS antenna port configuration. The set of instructions, when executed by one or more processors of the UE, may cause the UE to receive at least one CSI-RS based on the at least one reduced CSI-RS antenna port configuration and to compute CSI based at least on the at least one CSI-RS.

Some aspects described herein relate to a non-transitory computer-readable medium that stores a set of instructions for wireless communication by a network node. The set of instructions, when executed by one or more processors of the network node, may cause the network node to transmit a reduced antenna port indication for spatial element adaptation associated with at least one reduced CSI-RS antenna port configuration. The set of instructions, when executed by one or more processors of the network node, may cause the network node to transmit at least one CSI-RS based on the at least one reduced CSI-RS antenna port configuration.

Some aspects described herein relate to an apparatus for wireless communication. The apparatus may include means for receiving a pattern table indication for spatial element adaptation associated with at least one CSI-RS pattern table of a plurality of CSI-RS pattern tables, each CSI-RS pattern table of the plurality of CSI-RS pattern tables indicating a respective set of CSI-RS resource patterns. The apparatus may include means for receiving a pattern indication associated with an CSI-RS resource pattern indicated by the at least one CSI-RS pattern table. The apparatus may include means for receiving at least one CSI-RS based on the CSI-RS resource pattern and means for computing CSI based at least on the at least one CSI-RS.

Some aspects described herein relate to an apparatus for wireless communication. The apparatus may include means for transmitting a pattern table indication for spatial element adaptation associated with at least one CSI-RS pattern table of a plurality of CSI-RS pattern tables, each CSI-RS pattern table of the plurality of CSI-RS pattern tables indicating a respective set of CSI-RS resource patterns. The apparatus may include means for transmitting a pattern indication associated with an CSI-RS resource pattern indicated by the at least one CSI-RS pattern table. The apparatus may include means for transmitting at least one CSI-RS based on the CSI-RS resource pattern.

Some aspects described herein relate to an apparatus for wireless communication. The apparatus may include means for receiving a reduced antenna port indication for spatial element adaptation associated with at least one reduced CSI-RS antenna port configuration. The apparatus may include means for receiving at least one CSI-RS based on the at least one reduced CSI-RS antenna port configuration and means for computing CSI based at least on the at least one CSI-RS.

Some aspects described herein relate to an apparatus for wireless communication. The apparatus may include means for transmitting a reduced antenna port indication for spatial element adaptation associated with at least one reduced CSI-RS antenna port configuration. The apparatus may include means for transmitting at least one CSI-RS based on the at least one reduced CSI-RS antenna port configuration.

Aspects generally include a method, apparatus, system, computer program product, non-transitory computer-readable medium, user equipment, base station, network entity, network node, wireless communication device, and/or processing system as substantially described herein with reference to and as illustrated by the drawings, specification, and appendix.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIG. 4 is a diagram illustrating an example of antenna ports, in accordance with the present disclosure.

FIG. 5 is a diagram illustrating an example of physical channels and reference signals in a wireless network, in accordance with the present disclosure.

FIGS. 6A and 6B are diagrams illustrating an example of a channel state information reference signal (CSI-RS) port mapping, in accordance with the present disclosure.

FIG. 7A is a diagram illustrating examples of antenna adaptation, in accordance with the present disclosure.

FIG. 7B illustrates an example of a CSI-RS pattern and antenna port configuration associated with a nested structure, in accordance with the present disclosure.

FIG. 7C illustrates another example of a CSI-RS pattern and antenna port configuration associated with a nested structure, in accordance with the present disclosure.

FIG. 7D illustrates another example of a CSI-RS pattern and antenna port configuration associated with a nested structure, in accordance with the present disclosure.

FIGS. 7E and 7F illustrate examples of separate CSI-RS report configurations and a same CSI report configuration, respectively, for indicating the same CSI-RS resources with different CSI-RS antenna port configurations, in accordance with the present disclosure.

FIG. 8A is a diagram depicting an example associated with CSI feedback framework enhancements for adaptation of spatial elements, in accordance with the present disclosure.

FIG. 8B is another diagram depicting an example associated with CSI feedback framework enhancements for adaptation of spatial elements, in accordance with the present disclosure.

FIGS. 9A and 9B are diagrams illustrating examples of CSI-RS resource patterns, in accordance with the present disclosure.

FIGS. 10A and 10B are diagrams illustrating examples of reduced CSI-RS resource patterns, in accordance with the present disclosure.

FIG. 11 is a diagram illustrating an example process performed, for example, by a UE, in accordance with the present disclosure.

FIG. 12 is a diagram illustrating an example process performed, for example, by a network node, in accordance with the present disclosure.

FIG. 13 is a diagram illustrating an example process performed, for example, by a UE, in accordance with the present disclosure.

FIG. 14 is a diagram illustrating an example process performed, for example, by a network node, in accordance with the present disclosure.

FIG. 15 is a diagram of an example apparatus for wireless communication, in accordance with the present disclosure.

FIG. 16 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

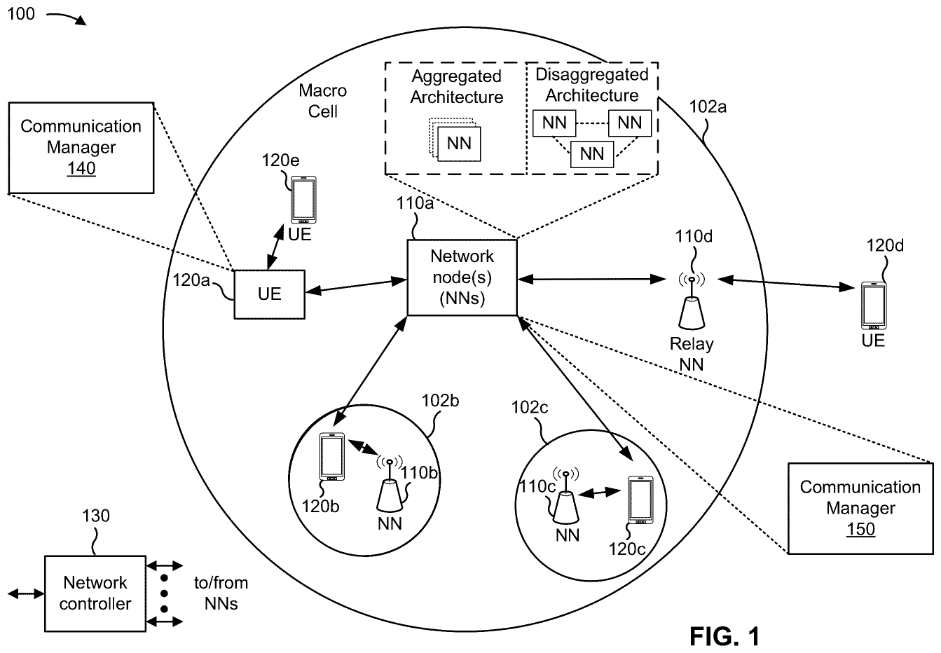

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120c), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an EMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120c) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ), FR4 (52.6 GHz-114.25 GHZ), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, a UE (e.g., the UE 120) may include a communication manager 140. As described in more detail elsewhere herein, the communication manager 140 may receive a pattern table indication for spatial element adaptation associated with at least one channel state information reference signal (CSI-RS) pattern table of a plurality of CSI-RS pattern tables, each CSI-RS pattern table of the plurality of CSI-RS pattern tables indicating a respective set of CSI-RS resource patterns; receive a pattern indication associated with an CSI-RS resource pattern indicated by the at least one CSI-RS pattern table; receive at least one CSI-RS based on the CSI-RS resource pattern; and determine (e.g., compute) channel state information (CSI) based at least on the received at least one CSI-RS.

In some aspects, the communication manager 140 may receive a reduced antenna port indication for spatial element adaptation associated with at least one reduced CSI-RS antenna port configuration; receive at least one CSI-RS based on the at least one reduced CSI-RS antenna port configuration; and determine (e.g., compute) CSI based at least on the received at least one CSI-RS. Additionally, or alternatively, the communication manager 140 may perform one or more other operations described herein.

In some aspects, a network node (e.g., the network node 110) may include a communication manager 150. As described in more detail elsewhere herein, the communication manager 150 may transmit a pattern table indication for spatial element adaptation associated with at least one CSI-RS pattern table of a plurality of CSI-RS pattern tables, each CSI-RS pattern table of the plurality of CSI-RS pattern tables indicating a respective set of CSI-RS resource patterns; transmit a pattern indication associated with an CSI-RS resource pattern indicated by the at least one CSI-RS pattern table; and transmit at least one CSI-RS based on the CSI-RS resource pattern.

In some aspects, the communication manager 150 may transmit a reduced antenna port indication for spatial element adaptation associated with at least one reduced CSI-RS antenna port configuration; and transmit at least one CSI-RS based on the at least one reduced CSI-RS antenna port configuration. Additionally, or alternatively, the communication manager 150 may perform one or more other operations described herein.

As indicated above, FIG. 1 is provided as an example. Other examples may differ from what is described with regard to FIG. 1.

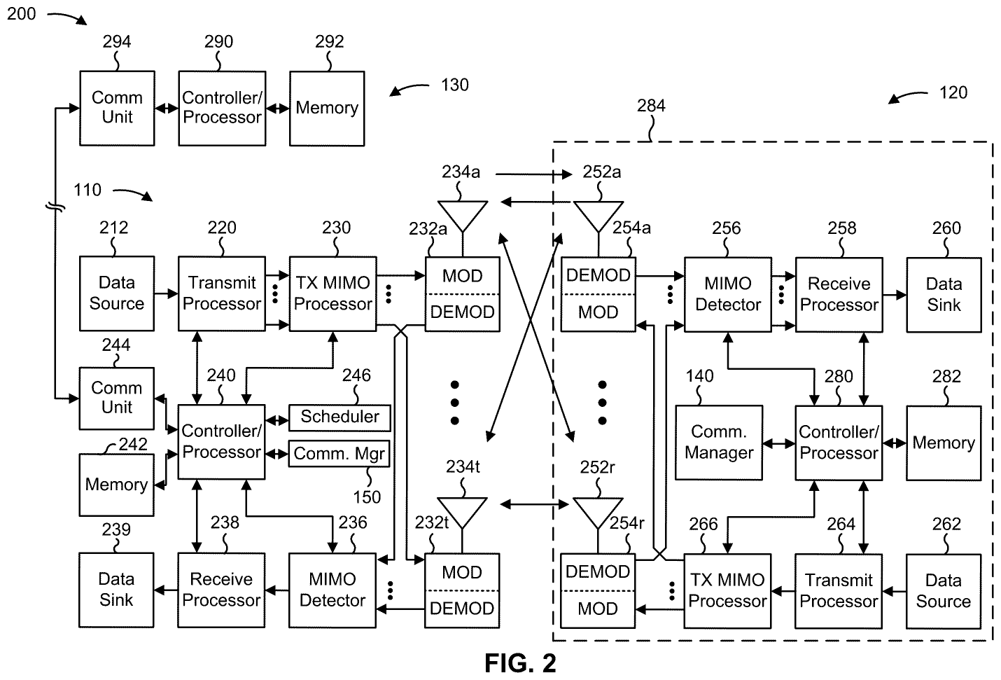

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a network node, such as for millimeter wave communications and/or the like. In such a case, the network node may provide the UE with a configuration of transmission configuration indicator (TCI) states that respectively indicate beams that may be used by the UE, such as for receiving a physical downlink shared channel (PDSCH). A TCI state indicates a spatial parameter for a communication. For example, a TCI state for a communication may identify a source signal (such as a synchronization signal block, a channel state information reference signal, or the like) and a spatial parameter to be derived from the source signal for the purpose of transmitting or receiving the communication. For example, the TCI state may indicate a quasi-co-location (QCL) type. A QCL type may indicate one or more spatial parameters to be derived from the source signal. The source signal may be referred to as a QCL source. The network node may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a QCL type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a CSI-RS (e.g., an NZP-CSI-RS-Resourceld, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

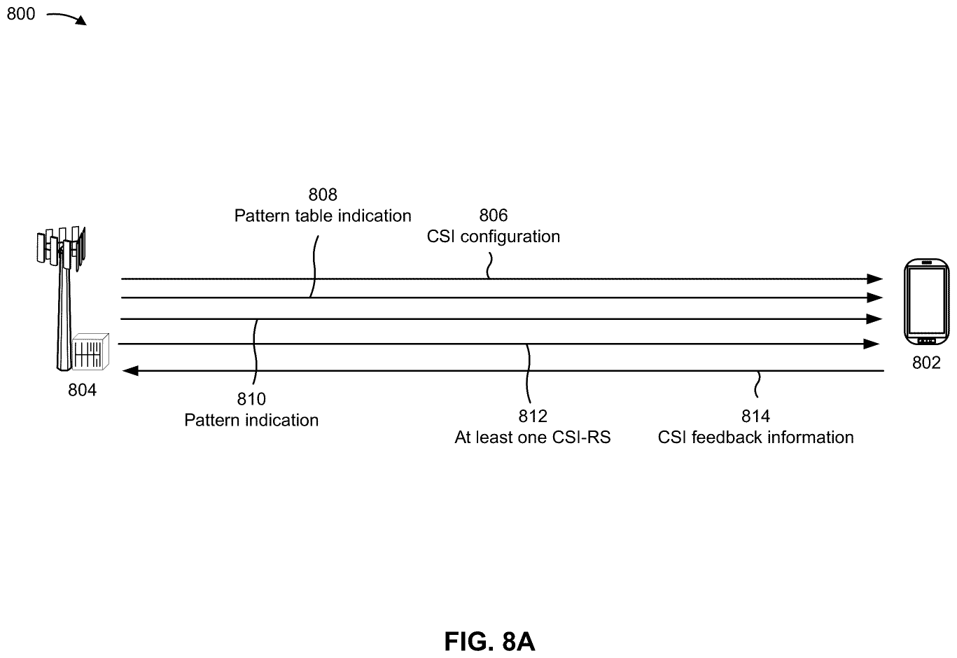

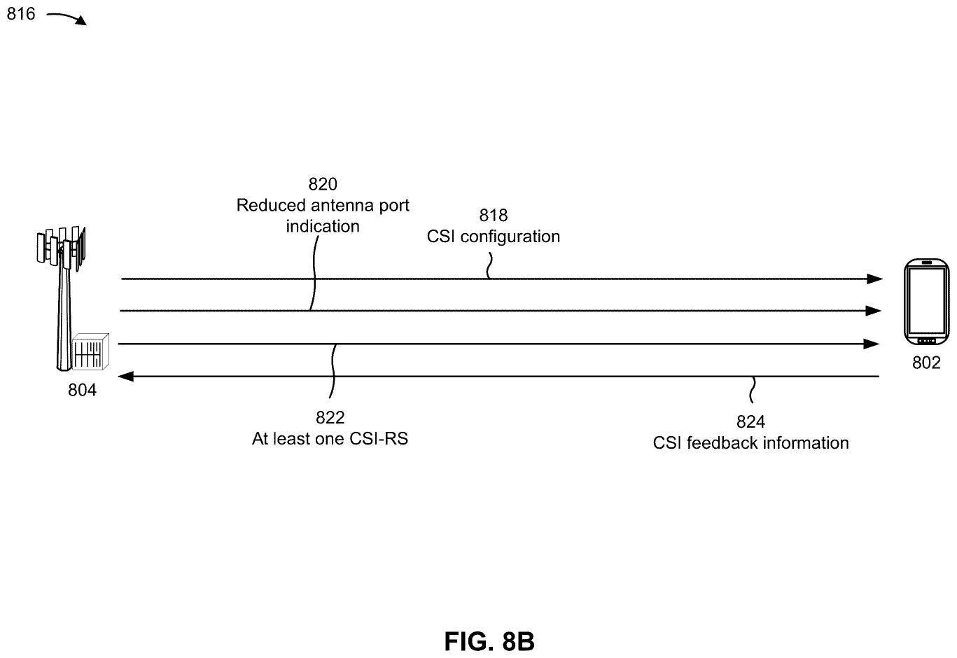

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 8A-16).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 8A-16).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

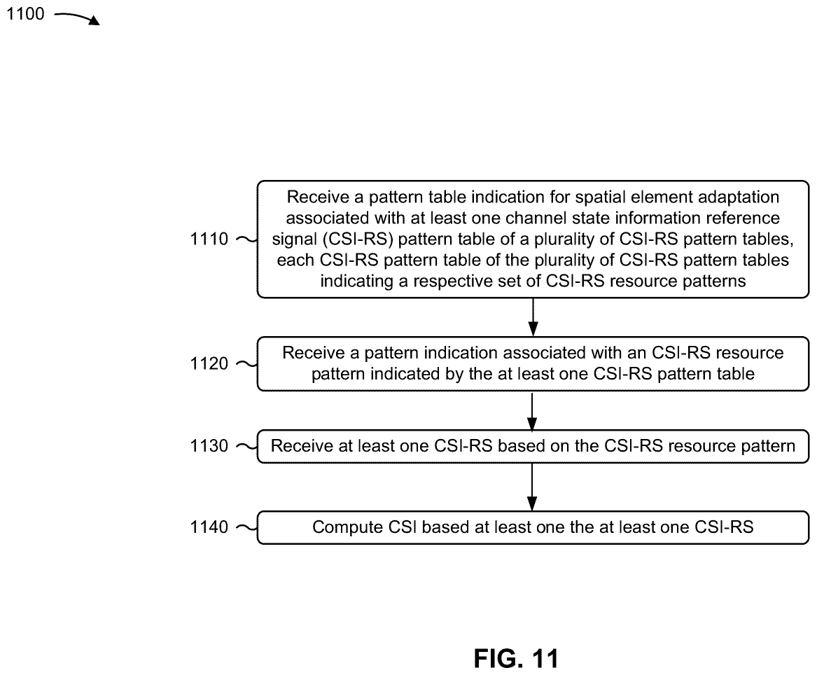

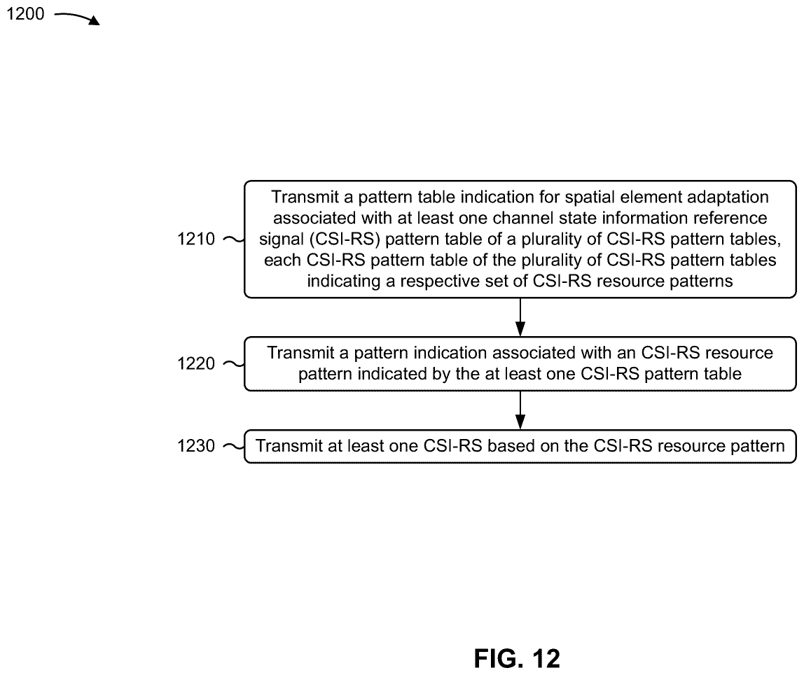

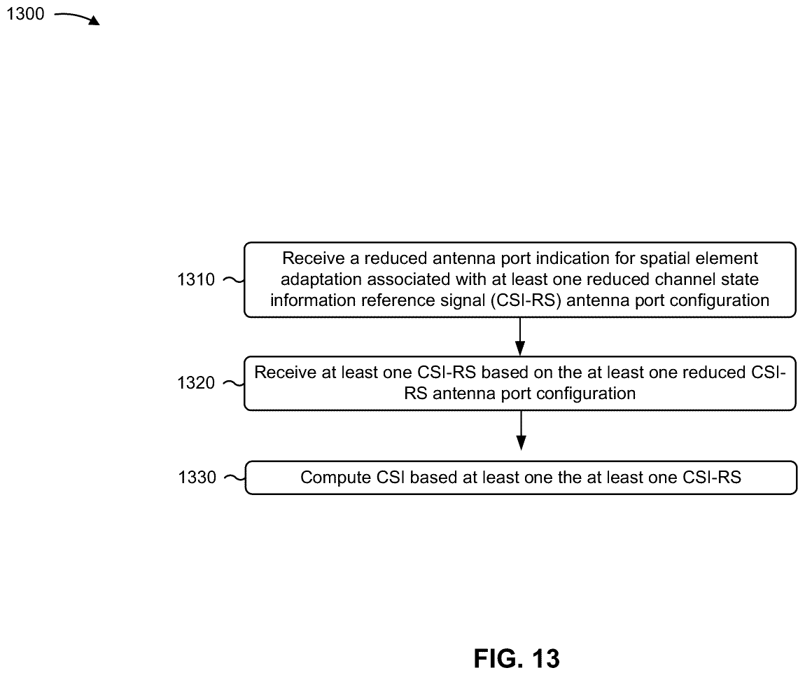

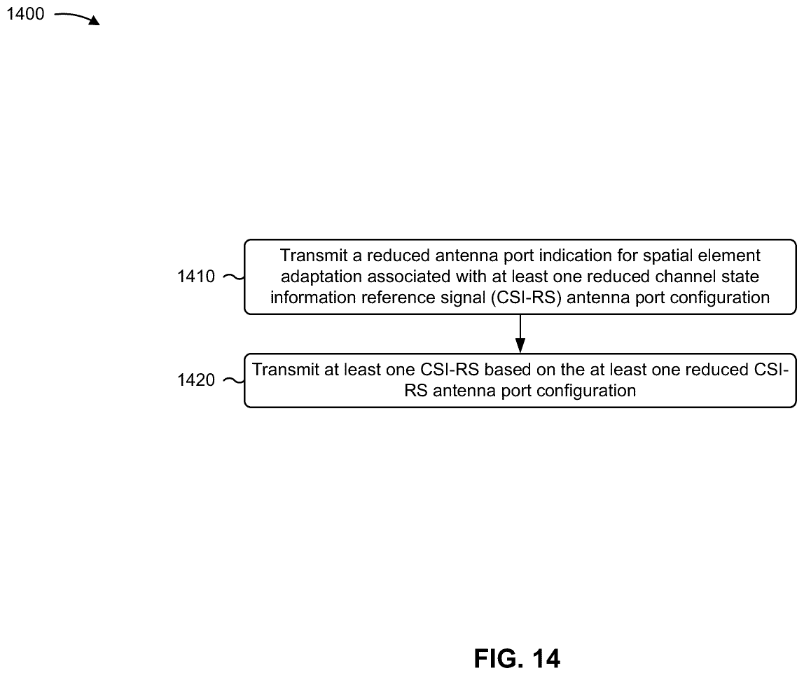

The controller/processor 240 of the network node 110, the controller/processor 280 of the UE 120, or any other component(s) of FIG. 2 may perform one or more techniques associated with channel state information (CSI) feedback framework enhancements for adaptation of spatial elements, as described in more detail elsewhere herein. For example, the controller/processor 240 of the network node 110, the controller/processor 280 of the UE 120, or any other component(s) (or combinations of components) of FIG. 2 may perform or direct operations of, for example, process 1100 of FIG. 11, process 1200 of FIG. 12, process 1300 of FIG. 13, process 1400 of FIG. 14, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1100 of FIG. 11, process 1200 of FIG. 12, process 1300 of FIG. 13, process 1400 of FIG. 14, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving a pattern table indication for spatial element adaptation associated with at least one CSI-RS pattern table of a plurality of CSI-RS pattern tables, each CSI-RS pattern table of the plurality of CSI-RS pattern tables indicating a respective set of CSI-RS resource patterns; means for receiving a pattern indication associated with an CSI-RS resource pattern indicated by the at least one CSI-RS pattern table; means for receiving at least one CSI-RS based on the CSI-RS resource pattern; and/or and means for determining (e.g., means for computing) CSI based at least on the received at least one CSI-RS.

In some aspects, the UE includes means for receiving a reduced antenna port indication for spatial element adaptation associated with at least one reduced CSI-RS antenna port configuration; means for receiving at least one CSI-RS based on the at least one reduced CSI-RS antenna port configuration; and/or and means for determining (e.g., means for computing) CSI based at least on the received at least one CSI-RS. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting a pattern table indication for spatial element adaptation associated with at least one CSI-RS pattern table of a plurality of CSI-RS pattern tables, each CSI-RS pattern table of the plurality of CSI-RS pattern tables indicating a respective set of CSI-RS resource patterns; means for transmitting a pattern indication associated with an CSI-RS resource pattern indicated by the at least one CSI-RS pattern table; and/or means for transmitting at least one CSI-RS based on the CSI-RS resource pattern.

In some aspects, the network node includes means for transmitting a reduced antenna port indication for spatial element adaptation associated with at least one reduced CSI-RS antenna port configuration; and/or means for transmitting at least one CSI-RS based on the at least one reduced CSI-RS antenna port configuration. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 220, TX MIMO processor 230, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (CNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

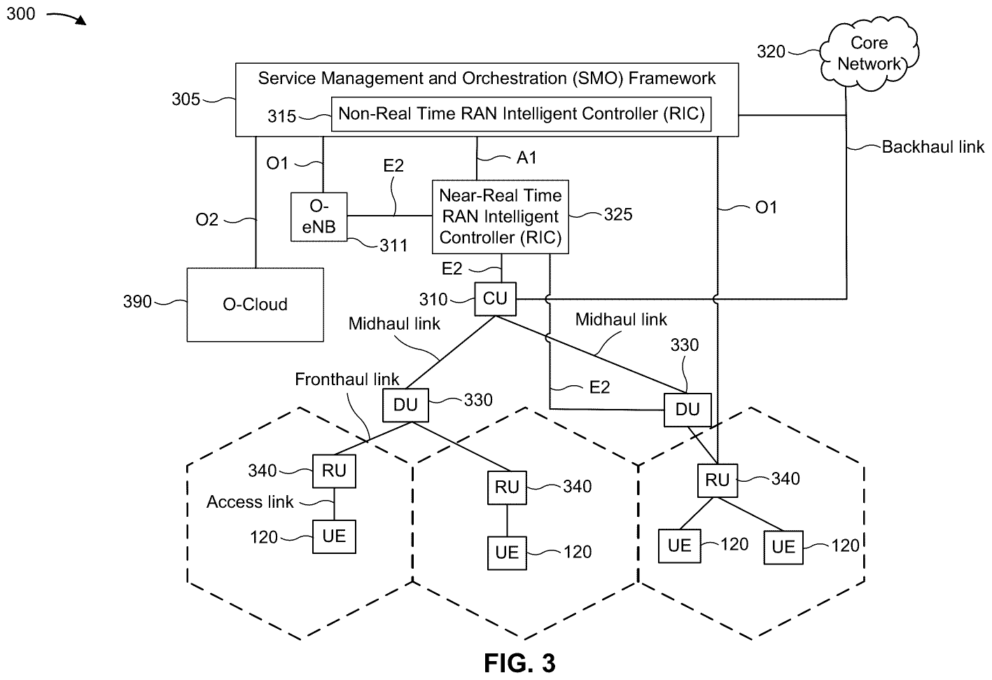

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through FI interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

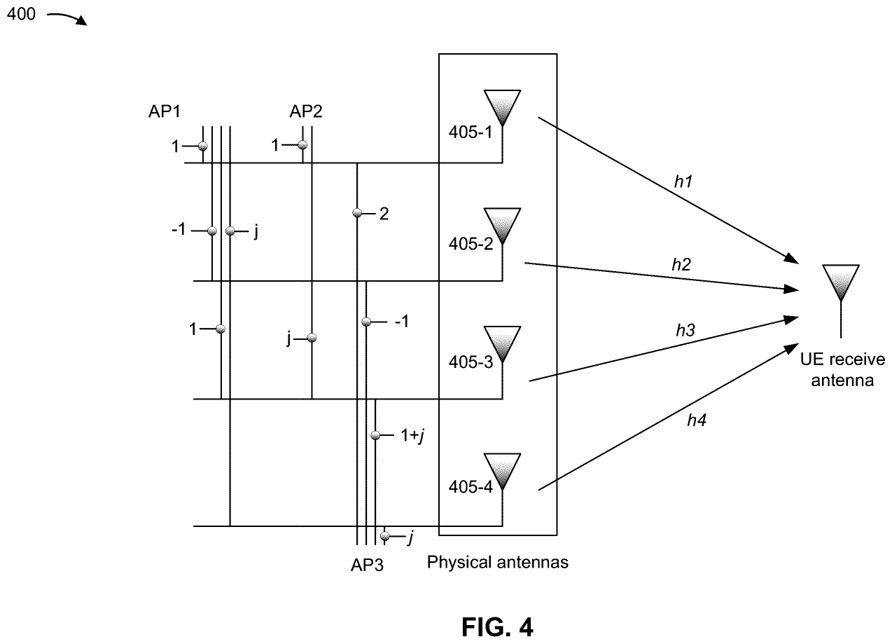

FIG. 4 is a diagram illustrating an example 400 of antenna ports, in accordance with the present disclosure.

As shown in FIG. 4, a first physical antenna 405-1 may transmit information via a first channel h1, a second physical antenna 405-2 may transmit information via a second channel h2, a third physical antenna 405-3 may transmit information via a third channel h3, and a fourth physical antenna 405-4 may transmit information via a fourth channel h4. Such information may be conveyed via a logical antenna port, which may represent some combination of the physical antennas and/or channels. In some cases, a UE 120 may not have knowledge of the channels associated with the physical antennas, and may only operate based on knowledge of the channels associated with antenna ports, as defined below.

An antenna port may be defined such that a channel, over which a symbol on the antenna port is conveyed, can be inferred from a channel over which another symbol on the same antenna port is conveyed. In example 400, a channel associated with antenna port 1 (AP1) is represented as h1−h2+h3+j*h4, where channel coefficients (e.g., 1, −1, 1, and j, in this case) represent weighting factors (e.g., indicating phase and/or gain) applied to each channel. Such weighting factors may be applied to the channels to improve signal power and/or signal quality at one or more receivers. Applying such weighting factors to channel transmissions may be referred to as precoding, and “precoder” may refer to a specific set of weighting factors applied to a set of channels.

Similarly, a channel associated with antenna port 2 (AP2) is represented as h1+j*h3, and a channel associated with antenna port 3 (AP3) is represented as 2*h1−h2+(1+j)*h3+j*h4. In this case, antenna port 3 can be represented as the sum of antenna port 1 and antenna port 2 (e.g., AP3=AP1+AP2) because the sum of the expression representing antenna port 1 (h1−h2+h3+j*h4) and the expression representing antenna port 2 (h1+j*h3) equals the expression representing antenna port 3 (2*h1−h2+(1+j)*h3+j*h4). It can also be said that antenna port 3 is related to antenna ports 1 and 2 [AP1,AP2] via the precoder [1,1] because 1 times the expression representing antenna port 1 plus 1 times the expression representing antenna port 2 equals the expression representing antenna port 3.

A network node may include antennas and antenna ports in a similar manner as described above. In some examples, a network node may include a larger quantity of physical antennas than a quantity of physical antennas associated with a UE. In some examples, antenna ports used by the network node may be indicated to a UE (e.g., in a radio resource control (RRC) configuration).

As indicated above, FIG. 4 is provided merely as an example. Other examples may differ from what is described with regard to FIG. 4.

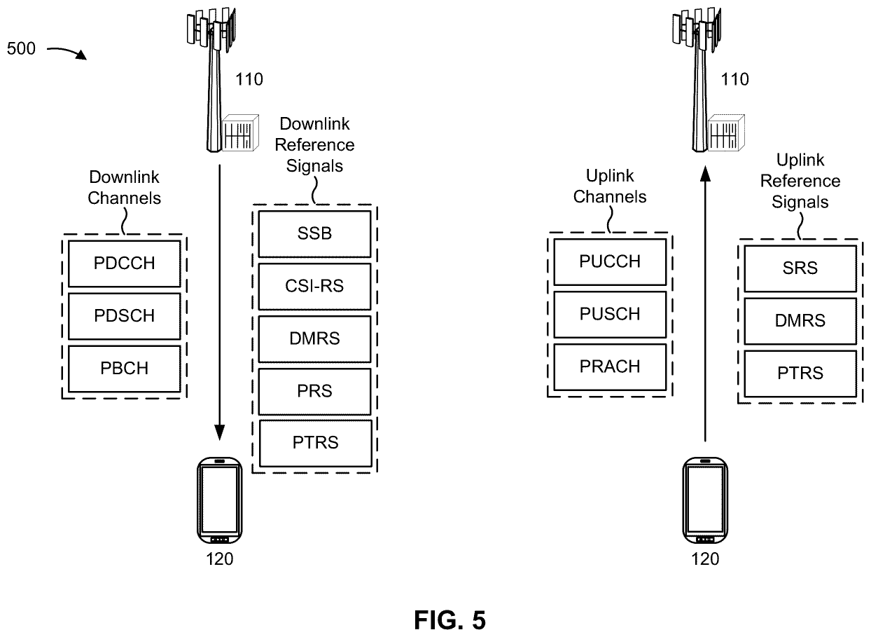

FIG. 5 is a diagram illustrating an example 500 of physical channels and reference signals in a wireless network, in accordance with the present disclosure. As shown in FIG. 5, downlink channels and downlink reference signals may carry information from a network node 110 to a UE 120, and uplink channels and uplink reference signals may carry information from a UE 120 to a network node 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a CSI-RS, a demodulation reference signal (DMRS), a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. In some examples, as part of the configuration for the CSI-RSs, the network node 110 may configure a CSI-RS port mapping that indicates CSI-RS ports used by the network node 110. As used herein, “CSI-RS port” may refer to an antenna port, of the network node, used to transmit a CSI-RS. The CSI-RS port mapping may map the CSI-RS ports to time-frequency resource locations. Based at least in part on the measurements of the CSI-RSs, the UE 120 may perform channel estimation and may report channel estimation parameters to the network node 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The network node 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

As indicated above, FIG. 5 is provided as an example. Other examples may differ from what is described with regard to FIG. 5.

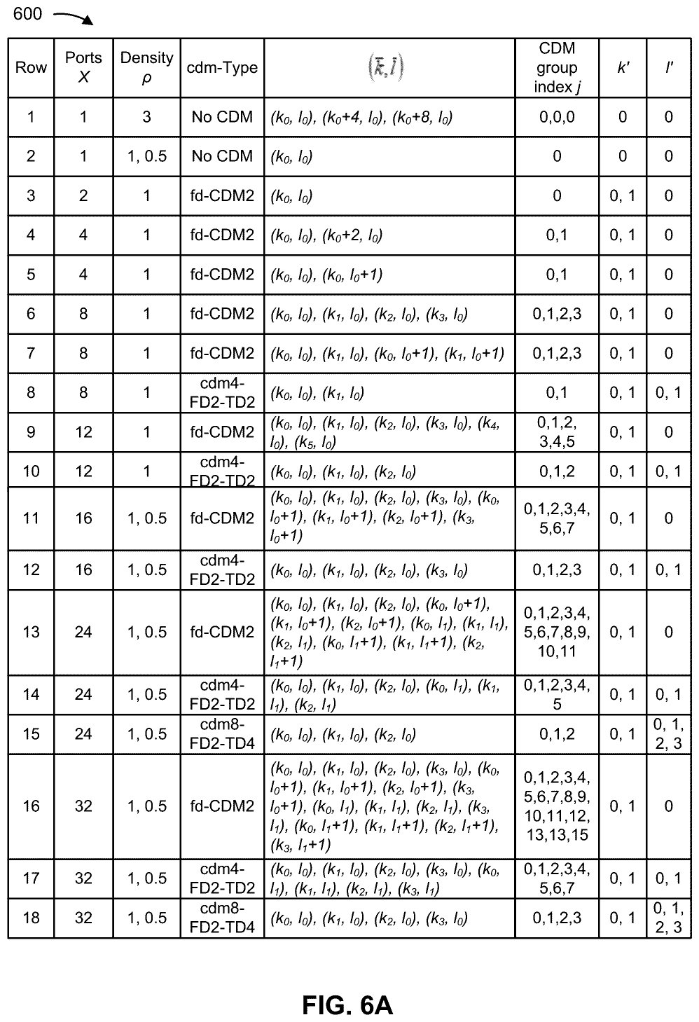

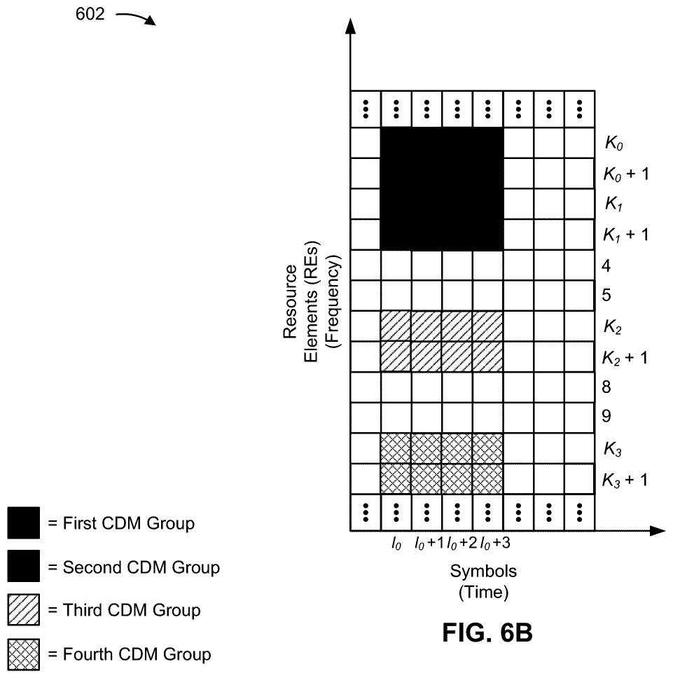

FIGS. 6A and 6B are diagrams illustrating an example 600 of a CSI-RS port mapping, in accordance with the present disclosure. The CSI-RS port mapping may also be referred to as a CSI-RS resource mapping. Time-frequency resources in a radio access network may be partitioned into resource blocks (RBs). An RB is sometimes referred to as a physical resource block (PRB). An RB includes a set of subcarriers (e.g., 12 subcarriers) and a set of symbols (e.g., 14 symbols) that are schedulable by a network node 110 as a unit. In some examples, an RB may include a set of subcarriers in a single slot. A single time-frequency resource included in an RB may be referred to as a resource element (RE). An RE may include a single subcarrier (e.g., in frequency) and a single symbol (e.g., in time). A symbol may be referred to as an orthogonal frequency division multiplexing (OFDM) symbol. An RE may be used to transmit one modulated symbol, which may be a real value or a complex value.

A CSI-RS may be based at least in part on a pseudo random sequence. For each CSI-RS that is configured, a UE may assume that a sequence is mapped to one or more REs. The mapping may be based at least in part on one or more parameters indicated by a CSI configuration (e.g., a CSI-RS-ResourceMapping information element (IE)) and/or another RRC configuration. The mapping of CSI-RS sequences to REs (e.g., to time-frequency resources) may be defined, or otherwise fixed, by a wireless communication standard, such as the 3GPP (e.g., 3GPP Technical Specification 38.211 Version 17.3.0 may define the mapping of CSI-RS sequences to REs). For example, as shown in FIG. 6A, the mapping may be based at least in part on a number of configured CSI-RS ports (e.g., which may be referred to as “Ports X”), a density (ρ), a code division multiplexing (CDM) type, one or more time domain and frequency domain locations (e.g., for a CDM group) (e.g., which may be referred to as (k̅, l̅), where k is a frequency domain resource location reference point and/is a time domain resource location reference point), a CDM group index (j), a frequency domain index within a CDM group (k′), and/or a time domain index within a CDM group (l′), among other examples. For example, 3GPP Technical Specification 38.211 Version 17.3.0 provides a table (which may be referred to as a CSI-RS pattern table and/or as “Table 2” and which is shown by example 600) with different entries (e.g., identified by a row index value) defining different CSI-RS resource locations for different values of the parameters described above. Each entry of the table may indicate a CSI-RS resource pattern.

The number of configured CSI-RS ports (e.g., Ports X) may be given by a higher layer (e.g., RRC) parameter, such as an nrofPorts parameter in a CSI-RS-ResourceMapping IE. The number of configured CSI-RS ports may be a number of CSI-RS ports configured for (e.g., available for use) by the network node 110. The density (p) may be given by a higher layer (e.g., RRC) parameter, such as a density parameter in the CSI-RS-ResourceMapping IE or in a CSI-RS-CellMobility IE. The density may indicate a quantity of CSI-RSs that are transmitted per-RB. For example, a density of 1 may indicate that 1 CSI-RS is transmitted in each RB. A density of 0.5 may indicate that 1 CSI-RS is transmitted in every other RB (e.g., every 2 RBs).

The CDM types may indicate a pattern associated with CDM groups associated with the CSI-RS transmission. For example, in a wireless communication system, multiple CSI-RS ports can be used to transmit on the same OFDM symbol using CDM and frequency division multiplexing (FDM). Using FDM, different CSI-RS ports can be used for transmission of CSI-RSs on the same OFDM symbol by using different sub-carriers (e.g., tones or REs) for different CSI-RS ports. Using CDM, different CSI-RS ports can be used for transmission of CSI-RSs on the same OFDM symbol (or across a set of OFDM symbols on the same subcarrier) by using different orthogonal cover codes (OCCs) for different CSI-RS ports. The CSI-RS ports that are used for transmission on the same sub-carrier belong to the same CDM group, and the CSI-RS ports that are used for transmission on different sub-carriers belong to different CDM groups. In other words, a CDM group includes a set of CSI-RS ports used for transmission of a respective set of CSI-RSs on the same sub-carrier, where different OCCs are used for (e.g., to scramble) transmissions on different CSI-RS ports included in the set of CSI-RS ports.

The one or more time domain and frequency domain locations (e.g., for a CDM group) ((k̅, l̅)) may provide starting locations for each CDM group in the time domain (l̅) and the frequency domain (k̅) for each CDM group associated with the CSI-RS transmission. A reference point for k=0 may be a subcarrier with an index value of “0” in common RB 0. Different k̅ values (e.g., k₀, k₁, k₂, and/or k₃) may be provided by a frequency domain resource allocation (e.g., a frequencyDomainAllocation parameter) in the CSI-RS-ResourceMapping IE or a CSI-RS-ResourceConfigMobility IE. Different l̅ values (e.g., l₀, and/or l₁) may be provided by a higher layer (e.g., RRC) parameter indicating a first OFDM symbol in the time domain for a CSI-RS (e.g., by a firstOFDMSymbolInTime Domain parameter (e.g., for l₀) or a firstOFDMSymbolInTimeDomain2 parameter (e.g., for l₁) in the CSI-RS-ResourceMapping IE or the CSI-RS-ResourceConfigMobility IE). The frequency domain index within a CDM group (k′) and the time domain index within a CDM group (l′) may provide RE indices for a given CDM group (e.g., relative to the k̅, l̅ values).

FIG. 6B depicts an example 602 of a CSI-RS resource mapping associated with 32 CSI-RS ports (e.g., a Ports X value of 32) and 4 CDM groups (e.g., a first CDM group, a second CDM group, a third CDM group, and a fourth CDM group). For example, the example 602 may depict a CSI-RS resource mapping corresponding to row 18 of the table depicted in FIG. 6A (e.g., the Table 7.3.1.5.3-1 in 3GPP Technical Specification 38.211 Version 16.7.0. For example, the example 600 may be associated with a Ports X value of 32, a density of 1 or 0.5, a CDM type of cdm8-FD2-TD4, and k̅, l̅ values of (k₀, l₀) (e.g., for the first CDM group), (k₁, l₀) (e.g., for the second CDM group), (k₂, l₀) (e.g., for the third CDM group), and (k₃, l₀) (e.g., for the fourth CDM group). The example 600 may be associated with k′ values of 0 and 1 (e.g., indicating that each CDM group includes an RE with index k̅ and an RE with index k̅+1. The example 600 may be associated with l′ values of 0, 1, 2, and 3 (e.g., indicating that each CDM group includes an RE with index l̅, l̅+1, l̅+2, and l̅+3). Based at least in part on the higher layer parameters configured for the CSI-RS, a UE may identify the CSI-RS time-frequency locations (e.g., in a similar manner as described above).

A single CSI-RS port may be mapped to each RE associated with the CSI-RS. For example, the network node 110 may sound (e.g., transmit using) a CSI-RS port at the RE associated with the CSI-RS port. For example, example 600 includes 32 REs that are associated with the CSI-RS. Each of the 32 REs may be associated with a single CSI-RS port (e.g., one of the 32 configured CSI-RS ports, as indicated by the nrofPorts parameter). The UE may monitor and/or measure the REs (e.g., the time-frequency locations) associated with the CSI-RS.

As indicated above, FIGS. 6A and 6B are provided as examples. Other examples may differ from what is described with regard to FIGS. 6A and 6B.

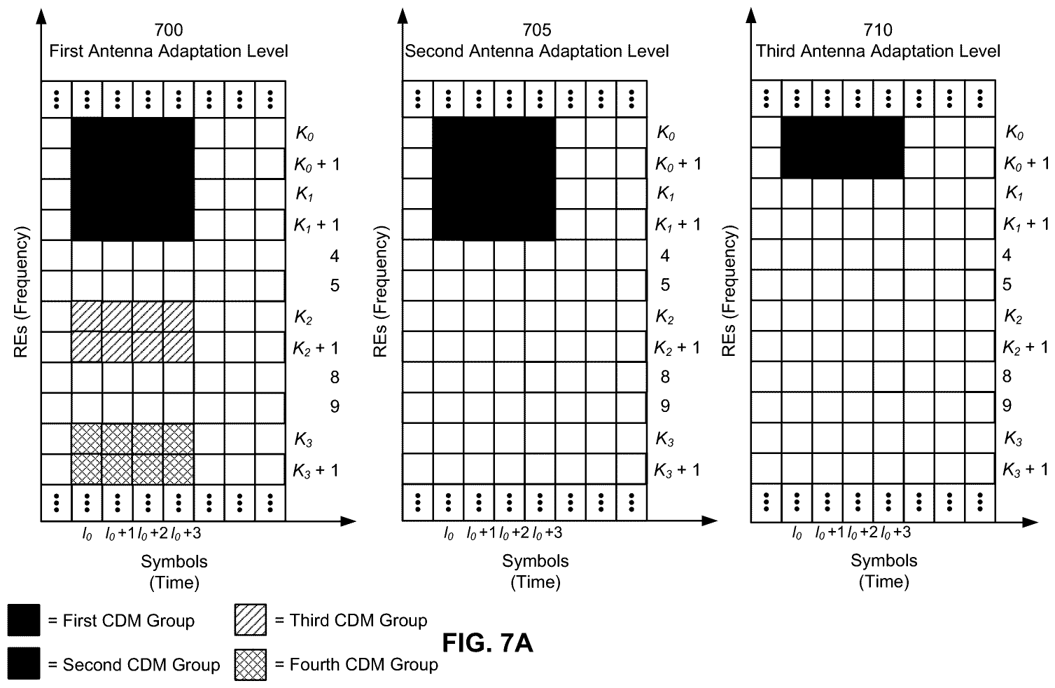

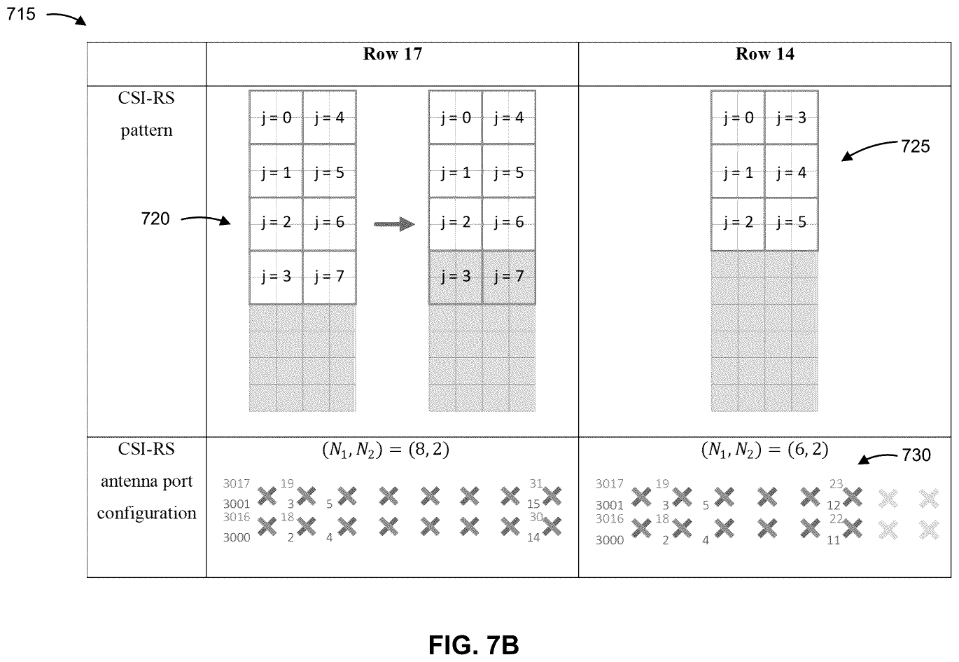

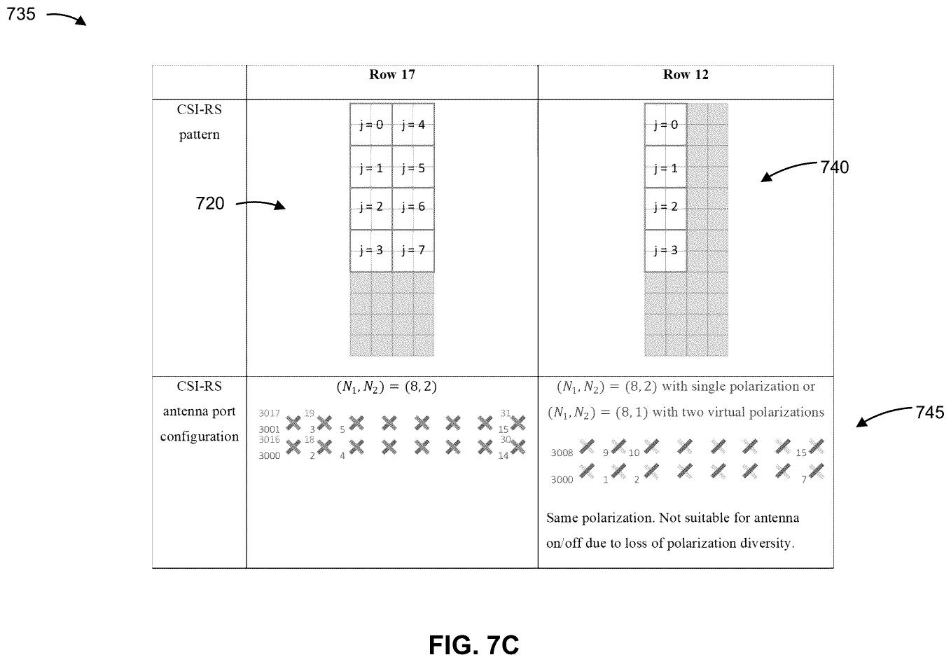

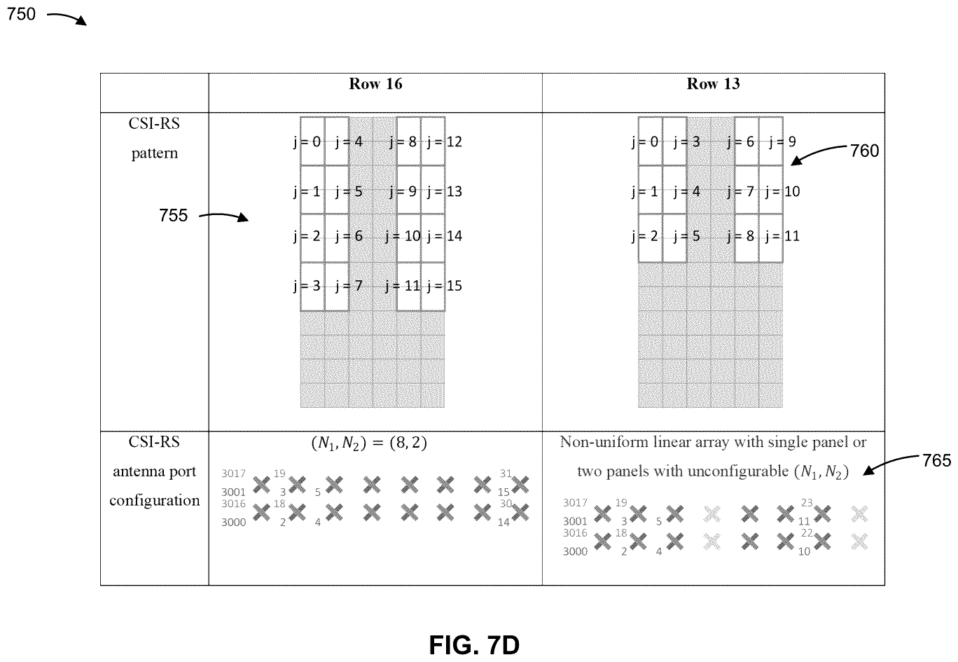

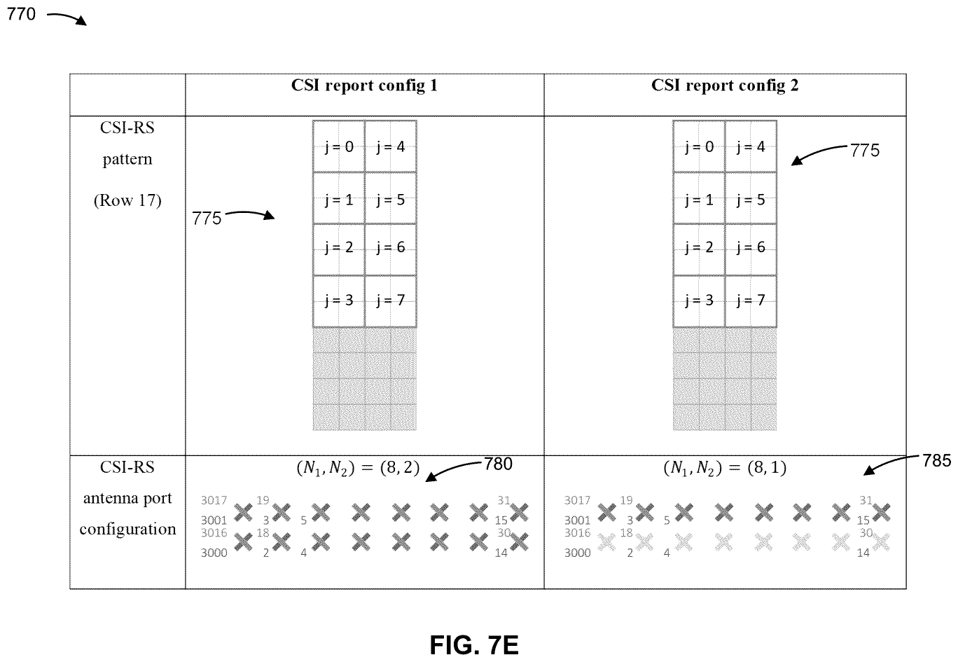

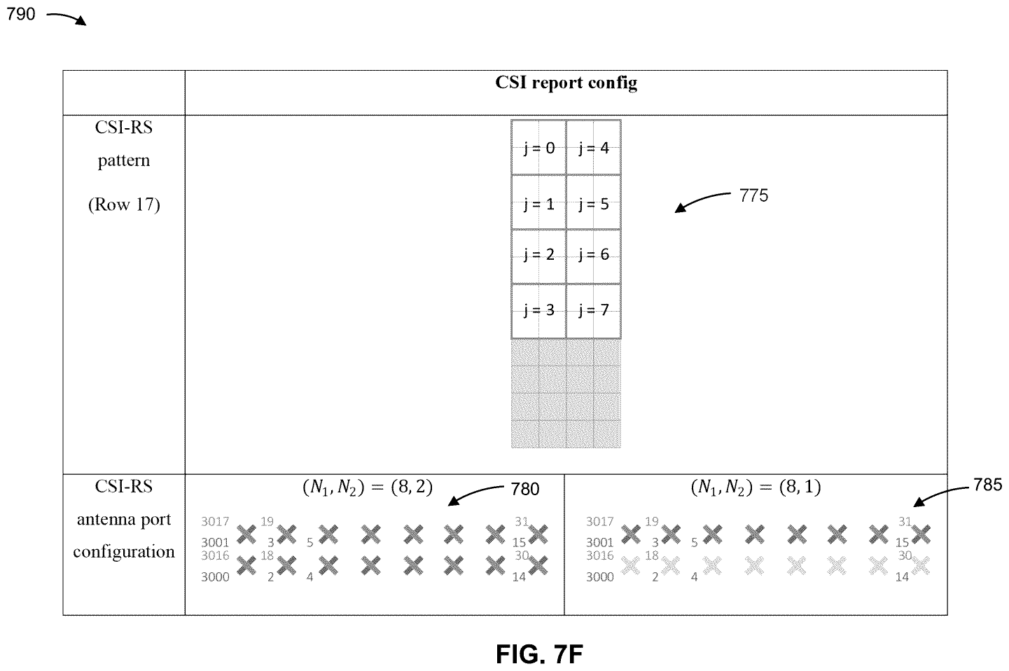

FIG. 7A is a diagram illustrating examples 700, 705, 710 of antenna adaptation, in accordance with the present disclosure. As used herein, “antenna adaptation” (which also may be referred to as “spatial element adaptation” or “adaptation of spatial elements”) may refer to dynamically changing a quantity of ports (e.g., CSI-RS ports) that are used by a network node for communication from among a quantity of ports (e.g., CSI-RS ports, which may be referred to as “antenna ports”) that are configured for use by the network node, that are available for use by the network node, and/or that may be used for deriving CSI-RS resources. Deriving a CSI-RS resource may include, for example, identifying a CSI-RS resource, determining a CSI-RS resource, and/or transmitting a CSI-RS using a CSI-RS resource, among other examples. For example, the network node may indicate a quantity of ports (e.g., a quantity of CSI-RS ports (Ports X), such as in the nrofPorts parameter) that are available for use by the network node, such as in an RRC configuration. In some cases, the network node may transmit using all of the configured ports or less than all of the configured ports. “Antenna adaptation” may also be referred to as “panel adaptation” or “antenna panel adaptation.” For example, the network node may dynamically adapt a quantity of antenna panels used by the network node in a similar manner as described herein.

For example, as a bandwidth used by wireless networks increases, a quantity of antennas at a network node may also increase to enable the network node to serve a larger bandwidth. However, using a large quantity of antennas (e.g., 64 antenna ports) may consume significant power at the network node. Therefore, in some cases, it may be desirable for the network node to use fewer antennas than are configured for use to conserve power. However, using fewer antennas may degrade communication performance for UEs being served by the network node. Therefore, the network node may use fewer antennas in certain circumstances (e.g., circumstances in which using fewer antennas does not, or does not significantly, degrade communication performance for UEs being served by the network node). For example, based at least in part on a network load (e.g., a quantity of UEs being served by the network node or an amount of uplink or downlink traffic being communicated by the network node), the network node may dynamically adapt a quantity of antennas (e.g., a quantity of antenna ports) used by the network node for transmissions (e.g., to conserve power). For example, when a network load decreases, the network node may use fewer antenna ports, and when the network load increases, the network node may use more antenna ports. The dynamic adaptation of the quantity of antennas (e.g., a quantity of antenna ports) used by the network node may be referred to herein as a network node applying antenna adaptation. The network node may use dynamic adaptation (e.g., rather than reconfiguring the quantity of antenna ports that are available for use by the network node, such as in an RRC configuration) because the conditions that enable the network node to apply antenna adaptation may change dynamically or rapidly over time. Reconfiguring the quantity of antenna ports that are available for use by the network node (e.g., in an RRC configuration) may be associated with significant delays (e.g., due to the signaling associated with the reconfiguration), which may result in different conditions existing when the reconfiguration is complete than when the reconfiguration was initiated. Therefore, the network node may use dynamic antenna adaptation to ensure that the quantity of antenna ports used by the network node is based on current network conditions or current network loads.

FIG. 7A depicts different antenna adaptation levels that may be applied by a network node. As used herein, “an antenna adaptation level” may refer to an indication of a quantity of antenna ports (e.g., CSI-RS ports) that are used by a network node relative to a quantity of antenna ports (e.g., CSI-RS ports) that are configured for use, or are available, at the network node. The different antenna adaptation levels in FIG. 7A are depicted with reference to a CSI-RS resource mapping (e.g., the CSI-RS resource mapping depicted in FIG. 6B). For example, when using a first antenna adaption level 700, the network node may use all of the configured antenna ports. For example, FIG. 7A depicts an example in which the network node has configured 32 CSI-RS ports to be available. When using the first antenna adaption level 700, the network node may transmit using all 32 CSI-RS ports. In other words, the first antenna adaption level 700 may indicate that the antenna ports (e.g., CSI-RS ports) used by the network node are all (e.g., 100%) of the configured antenna ports (e.g., of the configured CSI-RS ports).

When using a second antenna adaption level 705, the network node may use less than all of the configured antenna ports. For example, when using the second antenna adaption level 705, the network node may transmit using 16 CSI-RS ports of the 32 configured CSI-RS ports. In other words, the second antenna adaption level 705 may indicate that the antenna ports (e.g., CSI-RS ports) used by the network node are half (e.g., 50%) of the configured antenna ports (e.g., of the configured CSI-RS ports). For example, as shown in FIG. 7A, the network node may not transmit CSI-RS ports corresponding to REs included in the third CDM group and the fourth CDM group.

When using a third antenna adaption level 710, the network node may use less than all of the configured antenna ports. For example, when using the third antenna adaption level 710, the network node may transmit using 8 CSI-RS ports of the 32 configured CSI-RS ports. In other words, the third antenna adaption level 710 may indicate that the antenna ports (e.g., CSI-RS ports) used by the network node are a quarter (e.g., 25%) of the configured antenna ports (e.g., of the configured CSI-RS ports). For example, as shown in FIG. 7A, the network node may not transmit CSI-RS ports corresponding to REs included in the second CDM group, the third CDM group, and the fourth CDM group.

The first antenna adaption level 700, the second antenna adaption level 705, and the third antenna adaption level 710 are provided as examples, and other antenna adaptation levels are possible. For example, the network node may transmit using three-quarters (e.g., 75%) of the configured antenna ports (e.g., of the configured CSI-RS ports). In some examples, different antenna adaptation levels may correspond to a quantity of antenna panels used by the network node. For example, the second antenna adaptation level 705 may be associated with the network node using half of the antenna panels of the network node. Antenna adaptation may be similarly applied to other CSI-RS resource and/or port mappings in a similar manner as described herein.

However, some (or all) UEs being served by the network node may be unaware of the dynamic antenna adaptation applied by the network node. In other words, UEs may assume that all of the configured antenna ports (e.g., all of the configured CSI-RS ports) are used by the network node for all transmissions (e.g., for all CSI-RS transmissions). As a result, UEs may interpret CSI-RS port and/or resource mapping by inferring that all of the configured antenna ports (e.g., all of the configured CSI-RS ports) are used by the network node. In cases where the network node applies an antenna adaptation level that results in fewer than all of the configured antenna ports (e.g., all of the configured CSI-RS ports) being used by the network node, this may result in the UE monitoring and/or measuring REs that are not sounded by the network node. For example, when using the second antenna adaption level 705, the network node may not sound (e.g., may not transmit using) REs included in the third CDM group and the fourth CDM group.

However, the network node may still have all ports active while the UE measures CSI based on a subset of the active ports. The reported CSI feedback may assist the network node in performing adaptation.

In some cases, a network node can transmit, and a UE can receive, an indication of a set of CSI-RS port mappings for different antenna adaptation levels of the network node. Alternatively, the UE can receive the indication of a set of CSI-RS port mappings for different antenna adaptation levels of the network node based at least in part on pre-configured or pre-defined information. The network node can transmit, and the UE can receive, a CSI-RS in accordance with a first CSI-RS port mapping, from the set of CSI-RS port mappings, for a first antenna adaptation level of the different antenna adaptation levels. As a result, the UE can be enabled to identify a CSI-RS port mapping for the CSI-RS when the network node dynamically applies antenna adaptation (e.g., when the network node does not reconfigure the number of antenna ports or CSI-RS ports available, or configured, for use by the network node). Therefore, the UE can be enabled to correctly identify time-frequency locations of the CSI-RS. This enables the UE to correctly monitor for and measure the CSI-RS (e.g., when the network node is applying antenna adaptation).

In some cases, however, antenna adaptation can be more efficient if CSI reports associated with CSI trigger states provide useful information for the gNB to dynamically turn on/off spatial elements. In order to achieve such useful information, the CSI-RS resources associated with trigger states should have some special structure in time and frequency domain. In particular, they should have a nested structure such that when one or more CDM groups in an CSI-RS resource are muted (i.e., no CSI-RS transmission is assumed), the reduced CSI-RS resource pattern is one of the patterns provided in Table 2 (e.g., the CSI-RS pattern table of example 600) and the antenna array corresponding to the reduced CSI-RS resource pattern is a uniform linear array (which is assumption for codebook design) with supported configuration in provided in Table 5.2.2.2.1-2 (represented below as Table 1) and Table 5.2.2.2.2-1 of TS 38.214 v17.3.0 for Type-I single panel and Type-I multi-panel, respectively.

TABLE 1

| Number of CSI-RS | | Number of |
|---|---|---|
| antenna ports, P_{CSI-RS} | (N₁, N₂) | polarizations |
| 4 | (2, 1) | 2 |
| 8 | (2, 2) | 2 |
| | (4, 1) | 2 |
| 12 | (3, 2) | 2 |
| | (6, 1) | 2 |
| 16 | (4, 2) | 2 |
| | (8, 1) | 2 |
| 24 | (4, 3) | 2 |
| | (6, 2) | 2 |
| | (12, 1) | 2 |
| 32 | (4, 4) | 2 |
| | (8, 2) | 2 |
| | (16, 1) | 2 |

However, it has been observed that the CSI-RS resources associated with CSI report settings should have a nested structure such that when one or more CDM groups in an CSI-RS resource are assumed to be muted (e.g., no CSI-RS transmission), the reduced CSI-RS resource pattern is one of the patterns provided in “Table 2” (shown by example 600 in FIG. 6A) and the antenna array corresponding to the reduced CSI-RS resource pattern is a uniform linear array with a supported configuration provided in Table 5.2.2.2.1-2 and Table 5.2.2.2.2-1 of TS 38.214 version 17.3.0 for Type-I single panel and Type-I multi-panel, respectively. A CSI report setting may indicate, for example, a report quantity, a frequency, whether a CSI report is aperiodic, periodic, or semi-persistent, or the like.

FIG. 7B illustrates an example 715 of a CSI-RS pattern and antenna port configuration associated with a nested structure, in accordance with the present disclosure. In example 715, a network node deploys a 32-port CSI-RS resource pattern 720 as specified in row 17 of “Table 2” (shown by example 600 in FIG. 6A) with a choice of k₀=0, 2, 4, 8; l₀=10 and Type I single-panel codebook configuration (N₁, N₂)=(8,2). In the example 715, the network node determines to turn off transceiver chains associated with CSI-RS antenna ports having time/frequency mapping into the 4^{th} CDM group (i.e., j=3) and the 8^{th} CDM group (i.e., j=7). In other words, the network node does not transmit CSI-RS in the 4^{th} CDM group and the 8th CDM group. As a result, the reduced CSI-RS resource pattern corresponding to the pattern in row 17 with re-indexing CDM group can become a 24-port CSI-RS resource pattern 725 as specified in row 14.

The Type I single-panel codebook configuration 730 corresponding to the reduced CSI-RS resource pattern 725 becomes (N₁, N₂)=(8,2) which is one of the configurations in Table 5.2.2.2.1-2 of TS 38.214. Note that the port indexing is based on TS 38.211, version 17.3.0. Hence, the resource pattern 725 in row 14 is nested in the resource pattern 720 in row 17. Thus, the network node can use the resource pattern 725 in row 14 to configure 24-port CSI-RS resources to turn off antenna ports in the first two antenna columns or the last two antenna columns of the antenna array (N₁,N₂)=(8,2).

FIG. 7C illustrates another example 735 of a CSI-RS pattern and antenna port configuration associated with a nested structure, in accordance with the present disclosure. In example 735, a network node deploys a 32-port CSI-RS resource pattern 720 as specified in row 17 of “Table 2” (shown by example 600 in FIG. 6A) with a choice of k₀=0, 2, 4, 8; l₀=10 and Type I single-panel codebook configuration (N₁, N₂)=(8,2). In the example 735, the network node determines to turn off transceiver chains associated with CSI-RS antenna ports having time/frequency mapping into the 5^{th}-8^{th} CDM groups (i.e., j=4-7). In other words, the network node does not transmit CSI-RS in the 4^{th}-8^{th} CDM groups. As a result, the reduced CSI-RS resource pattern 740 corresponding to the pattern 720 in row 17 can become a 16-port CSI-RS resource pattern 740 as specified in row 12.

The Type I single-panel codebook configuration 745 corresponding to the reduced CSI-RS resource pattern becomes (N₁, N₂)=(6, 2) but with only one polarization which may be arguably not one of the configurations in Table 5.2.2.2.1-2 of TS 38.214. To make the codebook configuration 745 compliant to a valid configuration, the reduced pattern 740 can be implemented with (N₁, N₂)=(6, 1) with two virtual polarizations. However, the virtual polarization implementation may downgrade the performance of CSI-RS and PDSCH due to loss of polarization diversity. Furthermore, for the case where both polarizations are mapped into the same transceiver chains, turning off the transceiver chains may not be possible. As a result, the reduced CSI-RS pattern 740 may not be efficient for adaptation of spatial elements.

FIG. 7D illustrates another example 750 of a CSI-RS pattern and antenna port configuration associated with a nested structure, in accordance with the present disclosure. In example 750, a network node deploys a 32-port CSI-RS resource pattern 755 as specified in row 16 of “Table 2” (shown by example 600 in FIG. 6A) with a choice of k₀=0, 2, 4, 8; l₀=12 and Type I single-panel codebook configuration (N₁, N₂)=(8,2). In the example 750, the network node determines to turn off transceiver chains associated with CSI-RS antenna ports having time/frequency mapping into the CDM groups with index j=3, 7, 11, 15. In other words, the network node does not transmit CSI-RS in the CDM groups with index j=3, 7, 11, 15. As a result, the reduced CSI-RS resource pattern 760 corresponding to the pattern 755 in row 16 can become 24-port CSI-RS resource pattern 760 as specified in row 13. However, the Type I single-panel codebook configuration 765 corresponding to the reduced CSI-RS resource pattern becomes a non-uniform linear array. If the reduced pattern 760 is treated with a Type I multi-panel codebook configuration, the antenna array is uniform linear array with (N_{g}, N₁, N₂)=(2, 3, 2) which is not supported by Table 5.2.2.2.2-1 of TS 38.214.

However, with the legacy time/frequency patterns of CSI-RS resources, a nested structure does not exist when CSI-RS resources in different CSI report settings have different CDM group sizes. Furthermore, for CSI-RS resources with the same CDM group size, only a few CSI-RS resource patterns have a nested structure. For example, for CDM8 (rows 15 & 18 of “Table 2”), the 24-port CSI-RS resource in row 15 is nested within 32-port CSI-RS resource in row 18.

For CDM4 (rows 8, 10, 12, 14 and 17 of Table 2), the 24-port CSI-RS resource in row 14 is nested within 32-port CSI-RS resource in row 17. CSI-RS resources in other rows with CDM4 are not nested within the 32-port CSI-RS resource in row 17 (because one polarization is not usable). For CDM2 (rows 3-7, 9, 11, 13 and 16 of “Table 2”), the 2-port CSI-RS resource in row 3 is nested within 32-port CSI-RS resource in row 16. The CSI-RS resources in other rows with CDM2 are not nested within the 32-port CSI-RS resource in row 16 because one polarization is not usable (row 11) and the others involve an invalid antenna array (rows 4-7, 9 and 13).

As discussed above, adaptation of spatial elements may only be able to be performed between a 32-port and a 24-port antenna array when using CDM8 or CDM4, and between a 32-port and a 2-port antenna array when using CDM2. This implementation can limit the amount of potential network energy savings gain from the dynamic adaptation of spatial elements. However, new CSI-RS frequency and time domain patterns for CSI feedback may enable efficient adaptation of spatial elements.

Some techniques and apparatuses described herein provide CSI feedback framework enhancements for adaptation of spatial elements. For example, “Table 2” and/or any number of additional CSI pattern tables may be specified in a wireless communication standard. A network node may transmit, and a UE may receive, a pattern table indication for spatial element adaptation associated with at least one CSI-RS pattern table of a plurality of CSI-RS pattern tables. Each CSI-RS pattern table of the plurality of CSI-RS pattern tables may indicate a respective set of CSI-RS resource patterns. The network node may transmit, and the UE may receive, a pattern indication associated with an CSI-RS resource pattern indicated by the at least one CSI-RS pattern table. The network node may transmit, and the UE may receive, at least one CSI-RS based on the CSI-RS resource pattern. As a result, the UE may be enabled to identify a CSI-RS port mapping for the CSI-RS when the network node dynamically applies antenna adaptation, and the network node may have more CSI-RS patterns from which to choose the adaptation, thereby facilitating more flexibility for realizing energy savings. By providing the indications, the UE may be enabled to correctly identify time-frequency locations of the CSI-RS. This enables the UE to correctly monitor for and measure the CSI-RS (e.g., when the network node is applying antenna adaptation). As a result, an accuracy and/or efficiency of CSI measurements performed by the UE may be improved. Additionally, enabling the UE to correctly monitor for and measure the CSI-RS may improve performance for the UE and/or scheduling determinations by the network node by improving the accuracy of CSI reported by the UE. Moreover, some aspects may enable the network node to efficiently use antenna adaptation (e.g., without degrading a performance of UEs within the wireless network), thereby enabling the network node to conserve power.

In some aspects, for adaption of spatial elements, the same CSI-RS resources can be configured for one or more CSI report configurations. However, different CSI-RS antenna port configurations can be associated with the CSI-RS resources. This can be achieved via separate CSI report configurations or via the same CSI report configuration.

FIGS. 7E and 7F illustrate examples 770 and 790 of separate CSI-RS report configurations and a same CSI report configuration, respectively, for indicating the same CSI-RS resources with different CSI-RS antenna port configurations, in accordance with the present disclosure. As shown in example 770, a CSI-RS resource pattern 775 may be indicated separately with a first CSI-RS antenna port configuration 780 and a second CSI-RS antenna port configuration 785. As shown in example 790, the CSI-RS resource pattern 775 may be indicated once with the first CSI-RS antenna port configuration 780 and the second CSI-RS antenna port configuration 785.

Although the same CSI-RS resource configuration (e.g., 32-port CSI-RS resource) is configured for different CSI-RS antenna port configurations (e.g., 32-port and 16-port CSI-RS antenna port configurations), CQI computation for different CSI-RS antenna port configurations is different due to assumptions that PDSCH signals on antenna ports in the set [1000, . . . , 1000+v−1] for v layers would result in signals equivalent to corresponding symbols transmitted on antenna ports [3000, . . . , 3000+P−1], as given by

$$[ \begin{matrix}{y}^{( 3000 )} ( i ) \\ … \\ {y}^{( 3000 + P - 1 )} ( i )\end{matrix} ] = W ( i ) [ \begin{matrix}{x}^{( 0 )} ( i ) \\ … \\ {x}^{( v - 1 )} ( i )\end{matrix} ] ,$$

where x(i)=[x⁽⁰⁾(i) . . . x^{(v-1)}(i)]^{T} is a vector of PDSCH symbols from the layer mapping defined in Clause 7.3.1.4 of TS 38.211 version 17.3.0, where P∈[1,2,4,8,12,16,24,32] is the number of CSI-RS ports specified in TS 38.214 version 17.3.0. However, indicating a subset of CSI-RS antenna ports (e.g., a reduced CSI-RS antenna port configuration) can allow the UE to estimate CSI for PDSCH to be transmitted in the active antenna ports.

Some techniques and apparatuses described herein provide additional and/or alternative CSI feedback framework enhancements for adaptation of spatial elements. For example, in some aspects, a network node may transmit, and a UE may receive, a reduced antenna port indication for spatial element adaptation associated with at least one reduced CSI-RS antenna port configuration. The network node may transmit, and the UE may receive, at least one CSI-RS based on the at least one reduced CSI-RS antenna port configuration. By enabling a CSI report based on a subset of CSI-RS antenna ports in the CSI-RS resource configured in an CSI report setting, some aspects may improve network flexibility in selecting active spatial elements for the adaptation of spatial elements.

As indicated above, FIGS. 7A-7F are provided as examples. Other examples may differ from what is described with regard to FIGS. 7A-7F.

FIG. 8A is a diagram depicting an example 800 associated with CSI feedback framework enhancements for adaptation of spatial elements, in accordance with the present disclosure. As shown, a UE 802 and a network node 804 may communicate with one another. In some aspects, the UE 802 may be, be similar to, include, or be included in, the UE 120 depicted in FIGS. 1-3. In some aspects, the network node 804 may be, be similar to, include, or be included in, the network node 110 depicted in FIGS. 1 and 2, and/or one or more components of the disaggregated base station architecture 300 depicted in FIG. 3.

As shown by reference number 806, the network node 804 may transmit, and the UE 802 may receive, a CSI configuration. In some aspects, the CSI configuration may configure a plurality of CSI-RS resources available for use in transmitting CSI-RSs. As shown by reference number 808, the network node 804 may transmit, and the UE 802 may receive, a pattern table indication. In some aspects, the pattern table indication may be carried in an RRC message, a MAC CE, or a DCI communication.

The pattern table indication may be configured for spatial element adaptation associated with at least one CSI-RS pattern table of a plurality of CSI-RS pattern tables. Each CSI-RS pattern table of the plurality of CSI-RS pattern tables may indicate a respective set of CSI-RS resource patterns. For example, once of the at least one CSI-RS pattern tables may include the “Table 2,” and at least one additional CSI-RS pattern table may include additional CSI-RS resource patterns to those included in “Table 2.” In some aspects, for example, the plurality of CSI-RS pattern tables may include a first CSI-RS pattern table and a second CSI-RS pattern table, the first CSI-RS pattern table indicating a first set of CSI-RS resource patterns and the second CSI-RS pattern table indicating a second set of CSI-RS resource patterns. In some aspects, the first CSI-RS pattern table may include a first quantity of CSI-RS patterns and the second CSI-RS pattern table may include a second quantity of CSI-RS patterns. The first quantity may be the same as, or different from, the second quantity.

As shown by reference number 810, the network node 804 may transmit, and the UE 802 may receive, a pattern indication. The pattern indication may be associated with an CSI-RS resource pattern indicated by the at least one CSI-RS pattern table. In some aspects, the pattern table indication includes the pattern indication and, in some other aspects, the pattern indication may be received via a separate communication from the communication carrying the pattern table indication.

As shown by reference number 812, the network node 804 may transmit, and the UE 802 may receive, at least one CSI-RS based on the CSI-RS resource pattern. As shown by reference number 814, the UE 802 may transmit, and the network node 804 may receive, CSI feedback information based on the at least one CSI-RS. In some aspects, the UE 802 may compute CSI based at least on the at least one CSI-RS and the CSI feedback information may include the computed CSI.

FIG. 8B is another diagram depicting an example 816 associated with CSI feedback framework enhancements for adaptation of spatial elements, in accordance with the present disclosure. As shown, a UE 802 and a network node 804 may communicate with one another. In some aspects, the UE 802 may be, be similar to, include, or be included in, the UE 120 depicted in FIGS. 1-3. In some aspects, the network node 804 may be, be similar to, include, or be included in, the network node 110 depicted in FIGS. 1 and 2, and/or one or more components of the disaggregated base station architecture 300 depicted in FIG. 3.

As shown by reference number 818, the network node 804 may transmit, and the UE 802 may receive, a CSI configuration. In some aspects, the CSI configuration may configure a plurality of CSI-RS resources available for use in transmitting CSI-RSs. As shown by reference number 820, the network node 804 may transmit, and the UE 802 may receive, a reduced antenna port indication (sometimes referred to as a port subset indication). The reduced antenna port indication may be configured for spatial element adaptation associated with at least one reduced CSI-RS antenna port configuration. In some aspects, the reduced antenna port indication may include a bitmap indicating, for each antenna port of a plurality of antenna ports of the UE, whether the antenna port is to be used for deriving a CSI-RS resource.

In some aspects, receiving the reduced antenna port indication may include receiving a CSI report configuration including the reduced antenna port indication. In some aspects, the CSI report configuration may include at least one CSI report setting, and the at least one reduced CSI-RS antenna port configuration may correspond to the at least one CSI report setting. For example, in some aspects, the CSI report configuration comprises a plurality of CSI report sub-configurations. For example, in some aspects, if the CSI configuration has four sub-configurations, the UE 802 may compute four sets of CSI; if the CSI configuration is associated with periodic CSI reporting (e.g., as indicated by a CSI report setting), the UE 802 may compute four sets of CSI; if the CSI configuration is associated with semi-persistent reporting associated with a PUSCH or aperiodic CSI reporting, the network node 804 may indicate (e.g., using DCI) which CSI sub-configurations on which the UE 802 is to report; and if the CSI configuration is associated with semi-persistent reporting associated with a PUCCH, the network node 804 may indicate (e.g., using a MAC CE) which CSI sub-configurations on which the UE 802 is to report.

In some aspects, the CSI report configuration may include at least one additional reduced antenna port indication associated with at least one additional reduced CSI-RS antenna port configuration. In some aspects, the at least one CSI report setting may be a single CSI report setting common across all sub-configurations. In some aspects, the CSI report configuration may include a plurality of codebook configurations associated with a single CSI-RS resource. Each sub-configuration may include N₁ and N₂, or N₁, N₂, N_{g}, and a port subset indication, where Ng indicates a number of antenna panels. In some aspects, for example, each sub-configuration may include a subset of codebook configuration parameters and the port subset indication. Examples of codebook configurations are provided elsewhere herein.

As shown by reference number 822, the network node 804 may transmit, and the UE 802 may receive, at least one CSI-RS based on the at least one reduced CSI-RS antenna port configuration. As shown by reference number 824, the UE 802 may transmit, and the network node 804 may receive, CSI feedback information based on the at least one CSI-RS. In some aspects, the UE 802 may compute CSI based at least on the at least one CSI-RS and the CSI feedback information may include the computed CSI.

As indicated above, FIGS. 8A and 8B are provided as examples. Other examples may differ from what is described with regard to FIGS. 8A and 8B.

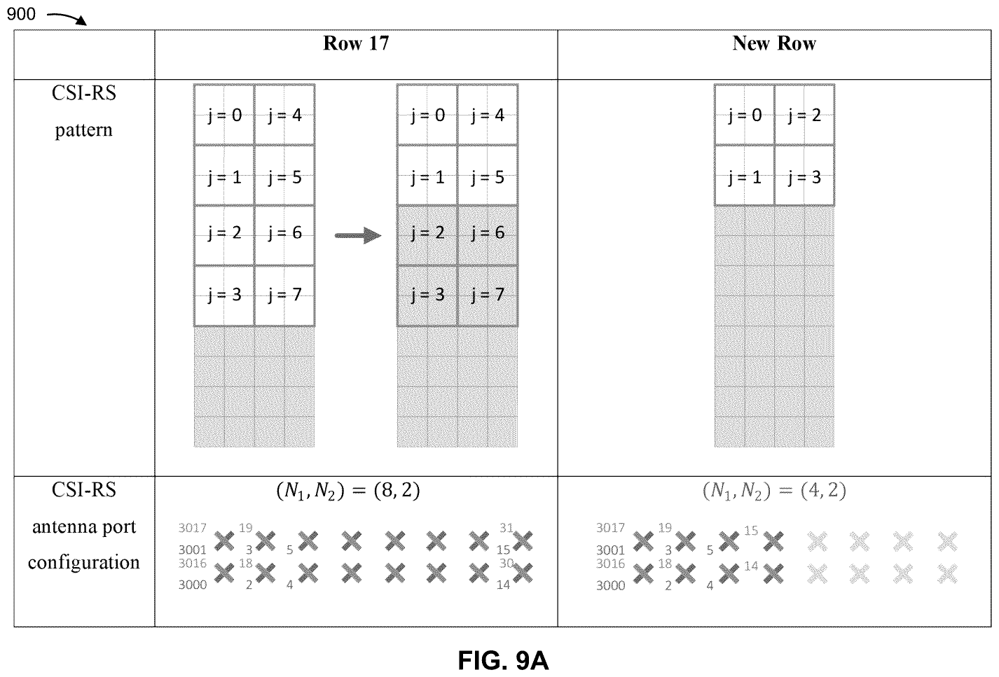

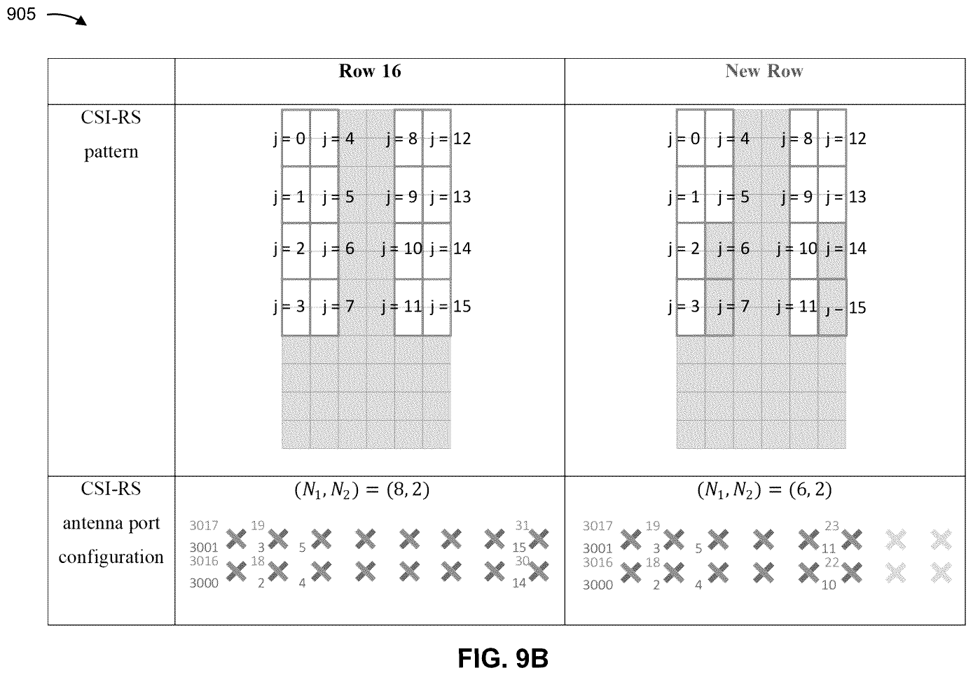

FIGS. 9A and 9B are diagrams illustrating examples 900 and 905 of CSI-RS resource patterns, in accordance with the present disclosure. As shown, example 900 includes a CSI-RS resource pattern that is nested within a pattern indicated in row 17 of “Table 2,” and example 905 shows a CSI-RS resource pattern that is nested within a pattern indicated in row 16 of “Table 2.”

As indicated above, FIGS. 9A and 9B are provided as examples. Other examples may differ from what is described with regard to FIGS. 9A and 9B.

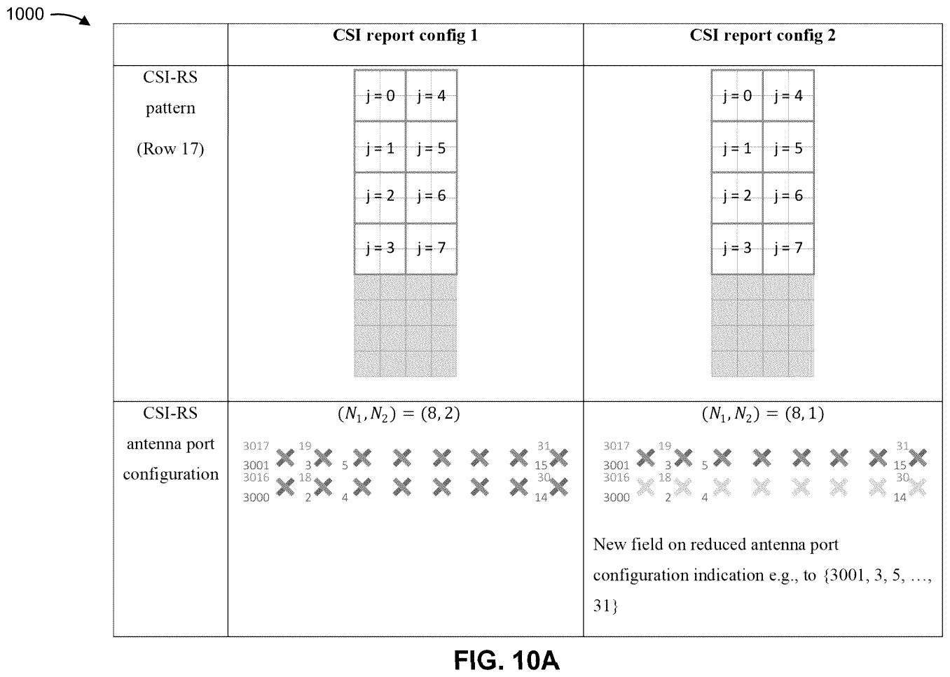

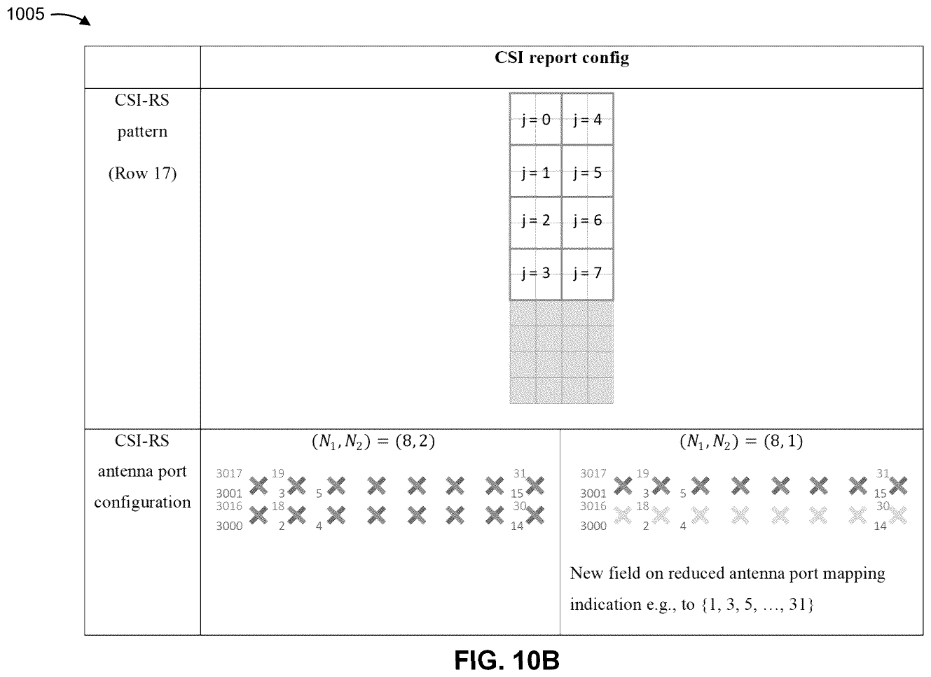

FIGS. 10A and 10B are diagrams illustrating examples 1000 and 1005 of reduced CSI-RS resource patterns, in accordance with the present disclosure. As shown, example 1000 shows separate CSI-RS resource pattern indications, having a field for indicating a reduced antenna port configuration and example 1005 shows a single CSI-RS resource pattern indication, having a field for indicating a reduced antenna port configuration.

As indicated above, FIG. 10 is provided as an example. Other examples may differ from what is described with regard to FIG. 10.

FIG. 11 is a diagram illustrating an example process 1100 performed, for example, by a UE, in accordance with the present disclosure. Example process 1100 is an example where the UE (e.g., UE 802) performs operations associated with techniques for CSI feedback framework enhancements for adaptation of spatial elements.

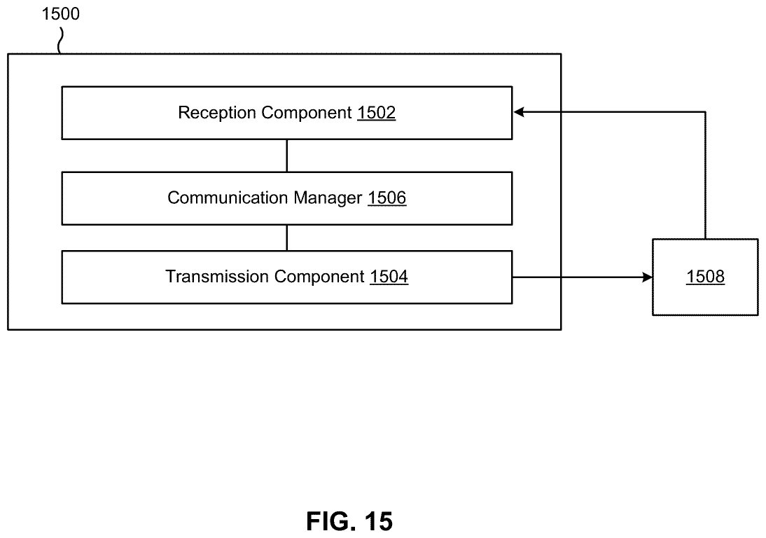

As shown in FIG. 11, in some aspects, process 1100 may include receiving a pattern table indication for spatial element adaptation associated with at least one CSI-RS pattern table of a plurality of CSI-RS pattern tables, each CSI-RS pattern table of the plurality of CSI-RS pattern tables indicating a respective set of CSI-RS resource patterns (block 1110). For example, the UE (e.g., using reception component 1502 and/or communication manager 1506, depicted in FIG. 15) may receive a pattern table indication for spatial element adaptation associated with at least one CSI-RS pattern table of a plurality of CSI-RS pattern tables, each CSI-RS pattern table of the plurality of CSI-RS pattern tables indicating a respective set of CSI-RS resource patterns, as described above.

As further shown in FIG. 11, in some aspects, process 1100 may include receiving a pattern indication associated with an CSI-RS resource pattern indicated by the at least one CSI-RS pattern table (block 1120). For example, the UE (e.g., using reception component 1502 and/or communication manager 1506, depicted in FIG. 15) may receive a pattern indication associated with an CSI-RS resource pattern indicated by the at least one CSI-RS pattern table, as described above.

As further shown in FIG. 11, in some aspects, process 1100 may include receiving at least one CSI-RS based on the CSI-RS resource pattern (block 1130). For example, the UE (e.g., using reception component 1502 and/or communication manager 1506, depicted in FIG. 15) may receive at least one CSI-RS based on the CSI-RS resource pattern, as described above.

As further shown in FIG. 11, in some aspects, process 1100 may include computing CSI based at least on the at least one CSI-RS (block 1140). For example, the UE (e.g., using reception component 1502 and/or communication manager 1506, depicted in FIG. 15) may compute CSI based at least on the at least one CSI-RS, as described above.

Process 1100 may include additional aspects, such as any single aspect or any combination of aspects described below and/or in connection with one or more other processes described elsewhere herein.

In a first aspect, the plurality of CSI-RS pattern tables comprises a first CSI-RS pattern table and a second CSI-RS pattern table, the first CSI-RS pattern table indicating a first set of CSI-RS resource patterns and the second CSI-RS pattern table indicating a second set of CSI-RS resource patterns.

In a second aspect, alone or in combination with the first aspect, the first CSI-RS pattern table includes a first quantity of CSI-RS patterns and wherein the second CSI-RS pattern table includes a second quantity of CSI-RS patterns.

In a third aspect, alone or in combination with the second aspect, the first quantity is different from the second quantity.

In a fourth aspect, alone or in combination with the second aspect, the first quantity is equal to the second quantity.

In a fifth aspect, alone or in combination with one or more of the first through fourth aspects, receiving the pattern table indication comprises receiving a first communication including the pattern table indication, and wherein receiving the pattern indication comprises receiving a second communication including the pattern indication.

In a sixth aspect, alone or in combination with one or more of the first through fourth aspects, the pattern table indication comprises the pattern indication.

In a seventh aspect, alone or in combination with one or more of the first through sixth aspects, receiving the pattern table indication comprises receiving a radio resource control message including the pattern table indication.

In an eighth aspect, alone or in combination with one or more of the first through sixth aspects, receiving the pattern table indication comprises receiving a medium access control control element including the pattern table indication.

In a ninth aspect, alone or in combination with one or more of the first through sixth aspects, receiving the pattern table indication comprises receiving a downlink control information communication including the pattern table indication.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network node, in accordance with the present disclosure. Example process 1200 is an example where the network node (e.g., network node 804) performs operations associated with techniques for CSI feedback framework enhancements for adaptation of spatial elements.

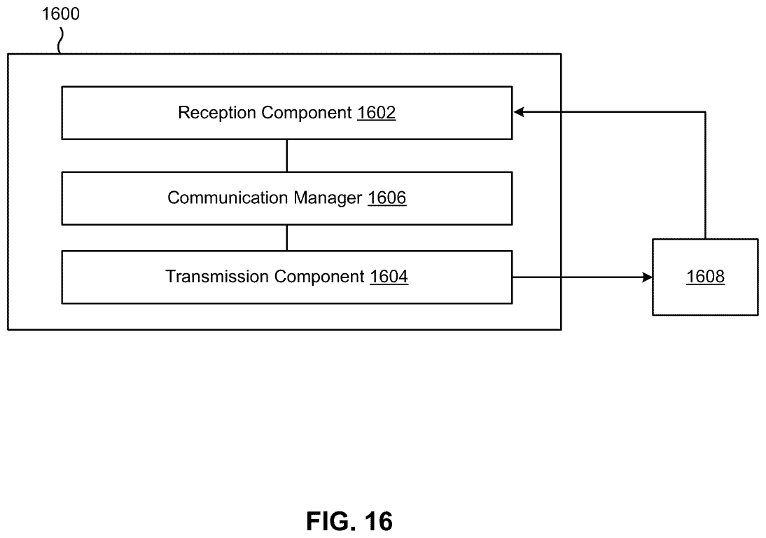

As shown in FIG. 12, in some aspects, process 1200 may include transmitting a pattern table indication for spatial element adaptation associated with at least one CSI-RS pattern table of a plurality of CSI-RS pattern tables, each CSI-RS pattern table of the plurality of CSI-RS pattern tables indicating a respective set of CSI-RS resource patterns (block 1210). For example, the network node (e.g., using transmission component 1604 and/or communication manager 1606, depicted in FIG. 16) may transmit a pattern table indication for spatial element adaptation associated with at least one CSI-RS pattern table of a plurality of CSI-RS pattern tables, each CSI-RS pattern table of the plurality of CSI-RS pattern tables indicating a respective set of CSI-RS resource patterns, as described above.

As further shown in FIG. 12, in some aspects, process 1200 may include transmitting a pattern indication associated with an CSI-RS resource pattern indicated by the at least one CSI-RS pattern table (block 1220). For example, the network node (e.g., using transmission component 1604 and/or communication manager 1606, depicted in FIG. 16) may transmit a pattern indication associated with an CSI-RS resource pattern indicated by the at least one CSI-RS pattern table, as described above.

As further shown in FIG. 12, in some aspects, process 1200 may include transmitting at least one CSI-RS based on the CSI-RS resource pattern (block 1230). For example, the network node (e.g., using transmission component 1604 and/or communication manager 1606, depicted in FIG. 16) may transmit at least one CSI-RS based on the CSI-RS resource pattern, as described above.

Process 1200 may include additional aspects, such as any single aspect or any combination of aspects described below and/or in connection with one or more other processes described elsewhere herein.

In a first aspect, the plurality of CSI-RS pattern tables comprises a first CSI-RS pattern table and a second CSI-RS pattern table, the first CSI-RS pattern table indicating a first set of CSI-RS resource patterns and the second CSI-RS pattern table indicating a second set of CSI-RS resource patterns.

In a second aspect, alone or in combination with the first aspect, the first CSI-RS pattern table includes a first quantity of CSI-RS patterns and wherein the second CSI-RS pattern table includes a second quantity of CSI-RS patterns.

In a third aspect, alone or in combination with the second aspect, the first quantity is different from the second quantity.

In a fourth aspect, alone or in combination with the second aspect, the first quantity is equal to the second quantity.

In a fifth aspect, alone or in combination with one or more of the first through fourth aspects, receiving the pattern table indication comprises receiving a first communication including the pattern table indication, and wherein receiving the pattern indication comprises receiving a second communication including the pattern indication.

In a sixth aspect, alone or in combination with one or more of the first through fourth aspects, the pattern table indication comprises the pattern indication.

In a seventh aspect, alone or in combination with one or more of the first through sixth aspects, transmitting the pattern table indication comprises transmitting a radio resource control message including the pattern table indication.

In an eighth aspect, alone or in combination with one or more of the first through sixth aspects, transmitting the pattern table indication comprises transmitting a medium access control control element including the pattern table indication.

In a ninth aspect, alone or in combination with one or more of the first through sixth aspects, transmitting the pattern table indication comprises transmitting a downlink control information communication including the pattern table indication.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a UE, in accordance with the present disclosure. Example process 1300 is an example where the UE (e.g., UE 802) performs operations associated with techniques for CSI feedback framework enhancements for adaptation of spatial elements.

As shown in FIG. 13, in some aspects, process 1300 may include receiving a reduced antenna port indication for spatial element adaptation associated with at least one reduced CSI-RS antenna port configuration (block 1310). For example, the UE (e.g., using reception component 1502 and/or communication manager 1506, depicted in FIG. 15) may receive a reduced antenna port indication for spatial element adaptation associated with at least one reduced CSI-RS antenna port configuration, as described above.

As further shown in FIG. 13, in some aspects, process 1300 may include receiving at least one CSI-RS based on the at least one reduced CSI-RS antenna port configuration (block 1320). For example, the UE (e.g., using reception component 1502 and/or communication manager 1506, depicted in FIG. 15) may receive at least one CSI-RS based on the at least one reduced CSI-RS antenna port configuration, as described above.

As further shown in FIG. 13, in some aspects, process 1300 may include computing CSI based at least on the at least one CSI-RS (block 1330). For example, the UE (e.g., using reception component 1502 and/or communication manager 1506, depicted in FIG. 15) may compute CSI based at least on the at least one CSI-RS, as described above

Process 1300 may include additional aspects, such as any single aspect or any combination of aspects described below and/or in connection with one or more other processes described elsewhere herein.

In a first aspect, receiving the reduced antenna port indication comprises receiving a CSI report configuration including the reduced antenna port indication.

In a second aspect, alone or in combination with the first aspect, the CSI report configuration comprises at least one CSI report setting, and wherein the at least one reduced CSI-RS antenna port configuration corresponds to the at least one CSI report setting.

In a third aspect, alone or in combination with one or more of the first and second aspects, the CSI report configuration comprises a plurality of codebook configurations associated with a single CSI-RS resource.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a network node, in accordance with the present disclosure. Example process 1400 is an example where the network node (e.g., network node 804) performs operations associated with techniques for CSI feedback framework enhancements for adaptation of spatial elements.

As shown in FIG. 14, in some aspects, process 1400 may include transmitting a reduced antenna port indication for spatial element adaptation associated with at least one reduced CSI-RS antenna port configuration (block 1410). For example, the network node (e.g., using transmission component 1604 and/or communication manager 1606, depicted in FIG. 16) may transmit a reduced antenna port indication for spatial element adaptation associated with at least one reduced CSI-RS antenna port configuration, as described above.

As further shown in FIG. 14, in some aspects, process 1400 may include transmitting at least one CSI-RS based on the at least one reduced CSI-RS antenna port configuration (block 1420). For example, the network node (e.g., using transmission component 1604 and/or communication manager 1606, depicted in FIG. 16) may transmit at least one CSI-RS based on the at least one reduced CSI-RS antenna port configuration, as described above.

Process 1400 may include additional aspects, such as any single aspect or any combination of aspects described below and/or in connection with one or more other processes described elsewhere herein.

In a first aspect, transmitting the reduced antenna port indication comprises transmitting a CSI report configuration including the reduced antenna port indication.

In a second aspect, alone or in combination with the first aspect, the CSI report configuration comprises at least one CSI report setting, and wherein the at least one reduced CSI-RS antenna port configuration corresponds to the at least one CSI report setting.

In a third aspect, alone or in combination with one or more of the first and second aspects, the CSI report configuration comprises a plurality of codebook configurations associated with a single CSI-RS resource.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a UE, or a UE may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 140 described in connection with FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIGS. 8A-10B. Additionally, or alternatively, the apparatus 1500 may be configured to perform one or more processes described herein, such as process 1100 of FIG. 11, process 1300 of FIG. 13, or a combination thereof. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the UE described in connection with FIG. 2.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, a modem, a modulator, a transmit MIMO processor, a transmit processor, a controller/processor, a memory, or a combination thereof, of the UE described in connection with FIG. 2. In some aspects, the transmission component 1504 may be co-located with the reception component 1502 in a transceiver.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

In some examples, means for transmitting, outputting, or sending (or means for outputting for transmission) may include one or more antennas, a modulator, a transmit MIMO processor, a transmit processor, or a combination thereof, of the UE described above in connection with FIG. 2.

In some examples, means for receiving (or means for obtaining) may include one or more antennas, a demodulator, a MIMO detector, a receive processor, or a combination thereof, of the UE described above in connection with FIG. 2.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for receiving, obtaining, transmitting, outputting, generating, performing, identifying, processing, and/or determining, may include various processing system components, such as a receive processor, a transmit processor, a controller/processor, a memory, or a combination thereof, of the UE described above in connection with FIG. 2.

The reception component 1502 may receive a pattern table indication for spatial element adaptation associated with at least one CSI-RS pattern table of a plurality of CSI-RS pattern tables, each CSI-RS pattern table of the plurality of CSI-RS pattern tables indicating a respective set of CSI-RS resource patterns. The reception component 1502 may receive a pattern indication associated with an CSI-RS resource pattern indicated by the at least one CSI-RS pattern table. The reception component 1502 may receive at least one CSI-RS based on the CSI-RS resource pattern. The communication manager 1506 may compute CSI based at least on the at least one CSI-RS.

The reception component 1502 may receive a reduced antenna port indication for spatial element adaptation associated with at least one reduced CSI-RS antenna port configuration. The reception component 1502 may receive at least one CSI-RS based on the at least one reduced CSI-RS antenna port configuration. The communication manager 1506 may compute CSI based at least on the at least one CSI-RS.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication, in accordance with the present disclosure. The apparatus 1600 may be a network node, or a network node may include the apparatus 1600. In some aspects, the apparatus 1600 includes a reception component 1602, a transmission component 1604, and/or a communication manager 1606, which may be in communication with one another (for example, via one or more buses and/or one or more other components). In some aspects, the communication manager 1606 is the communication manager 150 described in connection with FIG. 1. As shown, the apparatus 1600 may communicate with another apparatus 1608, such as a UE or a network node (such as a CU, a DU, an RU, or a base station), using the reception component 1602 and the transmission component 1604.

In some aspects, the apparatus 1600 may be configured to perform one or more operations described herein in connection with FIGS. 8A-10B. Additionally, or alternatively, the apparatus 1600 may be configured to perform one or more processes described herein, such as process 1200 of FIG. 12, process 1400 of FIG. 14, or a combination thereof. In some aspects, the apparatus 1600 and/or one or more components shown in FIG. 16 may include one or more components of the network node described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the network node described in connection with FIG. 2. In some aspects, the reception component 1602 and/or the transmission component 1604 may include or may be included in a network interface. The network interface may be configured to obtain and/or output signals for the apparatus 1600 via one or more communications links, such as a backhaul link, a midhaul link, and/or a fronthaul link.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1608. In some aspects, the transmission component 1604 may include one or more antennas, a modem, a modulator, a transmit MIMO processor, a transmit processor, a controller/processor, a memory, or a combination thereof, of the network node described in connection with FIG. 2. In some aspects, the transmission component 1604 may be co-located with the reception component 1602 in a transceiver.

The communication manager 1606 may support operations of the reception component 1602 and/or the transmission component 1604. For example, the communication manager 1606 may receive information associated with configuring reception of communications by the reception component 1602 and/or transmission of communications by the transmission component 1604. Additionally, or alternatively, the communication manager 1606 may generate and/or provide control information to the reception component 1602 and/or the transmission component 1604 to control reception and/or transmission of communications.

In some examples, means for transmitting, outputting, or sending (or means for outputting for transmission) may include one or more antennas, a modulator, a transmit MIMO processor, a transmit processor, or a combination thereof, of the network node described above in connection with FIG. 2.

In some examples, means for receiving (or means for obtaining) may include one or more antennas, a demodulator, a MIMO detector, a receive processor, or a combination thereof, of the network node described above in connection with FIG. 2.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for receiving, obtaining, transmitting, outputting, generating, performing, identifying, processing, and/or determining, may include various processing system components, such as a receive processor, a transmit processor, a controller/processor, a memory, or a combination thereof, of the network node described above in connection with FIG. 2.

The transmission component 1604 may transmit a pattern table indication for spatial element adaptation associated with at least one CSI-RS pattern table of a plurality of CSI-RS pattern tables, each CSI-RS pattern table of the plurality of CSI-RS pattern tables indicating a respective set of CSI-RS resource patterns. The transmission component 1604 may transmit a pattern indication associated with an CSI-RS resource pattern indicated by the at least one CSI-RS pattern table. The transmission component 1604 may transmit at least one CSI-RS based on the CSI-RS resource pattern.

The transmission component 1604 may transmit a reduced antenna port indication for spatial element adaptation associated with at least one reduced CSI-RS antenna port configuration. The transmission component 1604 may transmit at least one CSI-RS based on the at least one reduced CSI-RS antenna port configuration.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:
Aspect 1: A method of wireless communication performed by a user equipment (UE), comprising: receiving a pattern table indication for spatial element adaptation associated with at least one channel state information reference signal (CSI-RS) pattern table of a plurality of CSI-RS pattern tables, each CSI-RS pattern table of the plurality of CSI-RS pattern tables indicating a respective set of CSI-RS resource patterns; receiving a pattern indication associated with an CSI-RS resource pattern indicated by the at least one CSI-RS pattern table; receiving at least one CSI-RS based on the CSI-RS resource pattern; and computing channel state information (CSI) based at least on the at least one CSI-RS.
Aspect 2: The method of Aspect 1, wherein the plurality of CSI-RS pattern tables comprises a first channel state information reference signal (CSI-RS) pattern table and a second CSI-RS pattern table, the first CSI-RS pattern table indicating a first set of CSI-RS resource patterns and the second CSI-RS pattern table indicating a second set of CSI-RS resource patterns.
Aspect 3: The method of Aspect 2, wherein the first CSI-RS pattern table includes a first quantity of CSI-RS patterns and wherein the second CSI-RS pattern table includes a second quantity of CSI-RS patterns.
Aspect 4: The method of Aspect 3, wherein the first quantity is different from the second quantity.
Aspect 5: The method of Aspect 3, wherein the first quantity is equal to the second quantity.
Aspect 6: The method of any of Aspects 1-5, wherein receiving the pattern table indication comprises receiving a first communication including the pattern table indication, and wherein receiving the pattern indication comprises receiving a second communication including the pattern indication.
Aspect 7: The method of any of Aspects 1-5, wherein the pattern table indication comprises the pattern indication.
Aspect 8: The method of any of Aspects 1-7, wherein receiving the pattern table indication comprises receiving a radio resource control message including the pattern table indication.
Aspect 9: The method of any of Aspects 1-7, wherein receiving the pattern table indication comprises receiving a medium access control control element including the pattern table indication.
Aspect 10: The method of any of Aspects 1-7, wherein receiving the pattern table indication comprises receiving a downlink control information communication including the pattern table indication.
Aspect 11: A method of wireless communication performed by a network node, comprising: transmitting a pattern table indication for spatial element adaptation associated with at least one channel state information reference signal (CSI-RS) pattern table of a plurality of CSI-RS pattern tables, each CSI-RS pattern table of the plurality of CSI-RS pattern tables indicating a respective set of CSI-RS resource patterns; transmitting a pattern indication associated with an CSI-RS resource pattern indicated by the at least one CSI-RS pattern table; and transmitting at least one CSI-RS based on the CSI-RS resource pattern.
Aspect 12: The method of Aspect 11, wherein the plurality of CSI-RS pattern tables comprises a first channel state information reference signal (CSI-RS) pattern table and a second CSI-RS pattern table, the first CSI-RS pattern table indicating a first set of CSI-RS resource patterns and the second CSI-RS pattern table indicating a second set of CSI-RS resource patterns.
Aspect 13: The method of Aspect 12, wherein the first CSI-RS pattern table includes a first quantity of CSI-RS patterns and wherein the second CSI-RS pattern table includes a second quantity of CSI-RS patterns.
Aspect 14: The method of Aspect 13, wherein the first quantity is different from the second quantity.
Aspect 15: The method of Aspect 13, wherein the first quantity is equal to the second quantity.
Aspect 16: The method of any of Aspects 11-15, wherein receiving the pattern table indication comprises receiving a first communication including the pattern table indication, and wherein receiving the pattern indication comprises receiving a second communication including the pattern indication.
Aspect 17: The method of any of Aspects 11-15, wherein the pattern table indication comprises the pattern indication.
Aspect 18: The method of any of Aspects 11-17, wherein transmitting the pattern table indication comprises transmitting a radio resource control message including the pattern table indication.
Aspect 19: The method of any of Aspects 11-17, wherein transmitting the pattern table indication comprises transmitting a medium access control control element including the pattern table indication.
Aspect 20: The method of any of Aspects 11-17, wherein transmitting the pattern table indication comprises transmitting a downlink control information communication including the pattern table indication.
Aspect 21: A method of wireless communication performed by a user equipment (UE), comprising: receiving a reduced antenna port indication for spatial element adaptation associated with at least one reduced channel state information reference signal (CSI-RS) antenna port configuration; receiving at least one CSI-RS based on the at least one reduced CSI-RS antenna port configuration; and computing channel state information (CSI) based at least on the at least one CSI-RS.
Aspect 22: The method of Aspect 21, wherein receiving the reduced antenna port indication comprises receiving a channel state information (CSI) report configuration including the reduced antenna port indication.
Aspect 23: The method of Aspect 22, wherein the CSI report configuration comprises at least one CSI report setting, and wherein the at least one reduced CSI-RS antenna port configuration corresponds to the at least one CSI report setting.
Aspect 24: The method of either of Aspects 22 or 23, wherein the CSI report configuration comprises a plurality of codebook configurations associated with a single CSI-RS resource.
Aspect 25: A method of wireless communication performed by a network node, comprising: transmitting a reduced antenna port indication for spatial element adaptation associated with at least one reduced channel state information reference signal (CSI-RS) antenna port configuration; and transmitting at least one CSI-RS based on the at least one reduced CSI-RS antenna port configuration.
Aspect 26: The method of Aspect 25, wherein transmitting the reduced antenna port indication comprises transmitting a channel state information (CSI) report configuration including the reduced antenna port indication.
Aspect 27: The method of Aspect 26, wherein the CSI report configuration comprises at least one CSI report setting, and wherein the at least one reduced CSI-RS antenna port configuration corresponds to the at least one CSI report setting.
Aspect 28: The method of either of Aspects 26 or 27, wherein the CSI report configuration comprises a plurality of codebook configurations associated with a single CSI-RS resource.
Aspect 29: An apparatus for wireless communication at a device, comprising a processor; memory coupled with the processor; and instructions stored in the memory and executable by the processor to cause the apparatus to perform the method of one or more of Aspects 1-10.
Aspect 30: A device for wireless communication, comprising one or more memories and one or more processors coupled to the one or more memories, the one or more processors individually or collectively configured to perform the method of one or more of Aspects 1-10.
Aspect 31: An apparatus for wireless communication, comprising at least one means for performing the method of one or more of Aspects 1-10.
Aspect 32: A non-transitory computer-readable medium storing code for wireless communication, the code comprising instructions executable by a processor to perform the method of one or more of Aspects 1-10.
Aspect 33: A non-transitory computer-readable medium storing a set of instructions for wireless communication, the set of instructions comprising one or more instructions that, when executed by one or more processors of a device, cause the device to perform the method of one or more of Aspects 1-10.
Aspect 34: An apparatus for wireless communication at a device, comprising a processor; memory coupled with the processor; and instructions stored in the memory and executable by the processor to cause the apparatus to perform the method of one or more of Aspects 11-20.
Aspect 35: A device for wireless communication, comprising one or more memories and one or more processors coupled to the one or more memories, the one or more processors individually or collectively configured to perform the method of one or more of Aspects 11-20.
Aspect 36: An apparatus for wireless communication, comprising at least one means for performing the method of one or more of Aspects 11-20.
Aspect 37: A non-transitory computer-readable medium storing code for wireless communication, the code comprising instructions executable by a processor to perform the method of one or more of Aspects 11-20.
Aspect 38: A non-transitory computer-readable medium storing a set of instructions for wireless communication, the set of instructions comprising one or more instructions that, when executed by one or more processors of a device, cause the device to perform the method of one or more of Aspects 11-20.
Aspect 39: An apparatus for wireless communication at a device, comprising a processor; memory coupled with the processor; and instructions stored in the memory and executable by the processor to cause the apparatus to perform the method of one or more of Aspects 21-24 and 49-52.
Aspect 40: A device for wireless communication, comprising one or more memories and one or more processors coupled to the one or more memories, the one or more processors individually or collectively configured to perform the method of one or more of Aspects 21-24 and 49-52.
Aspect 41: An apparatus for wireless communication, comprising at least one means for performing the method of one or more of Aspects 21-24 and 49-52.
Aspect 42: A non-transitory computer-readable medium storing code for wireless communication, the code comprising instructions executable by a processor to perform the method of one or more of Aspects 21-24 and 49-52.
Aspect 43: A non-transitory computer-readable medium storing a set of instructions for wireless communication, the set of instructions comprising one or more instructions that, when executed by one or more processors of a device, cause the device to perform the method of one or more of Aspects 21-24 and 49-52.
Aspect 44: An apparatus for wireless communication at a device, comprising a processor; memory coupled with the processor; and instructions stored in the memory and executable by the processor to cause the apparatus to perform the method of one or more of Aspects 25-28 and 49-52.
Aspect 45: A device for wireless communication, comprising one or more memories and one or more processors coupled to the one or more memories, the one or more processors individually or collectively configured to perform the method of one or more of Aspects 25-28 and 49-52.
Aspect 46: An apparatus for wireless communication, comprising at least one means for performing the method of one or more of Aspects 25-28 and 49-52.
Aspect 47: A non-transitory computer-readable medium storing code for wireless communication, the code comprising instructions executable by a processor to perform the method of one or more of Aspects 25-28 and 49-52.
Aspect 48: A non-transitory computer-readable medium storing a set of instructions for wireless communication, the set of instructions comprising one or more instructions that, when executed by one or more processors of a device, cause the device to perform the method of one or more of Aspects 25-28 and 49-52.
Aspect 49: The method of Aspect 21 or 25, wherein the reduced antenna port indication comprises a bitmap indicating, for each antenna port of a plurality of antenna ports of the UE, whether the antenna port is to be used for deriving a CSI-RS resource.
Aspect 50: The method of any of Aspects 22-23 or 25-26, wherein the CSI report configuration comprises a plurality of CSI report sub-configurations.
Aspect 51: The method of Aspect 50, wherein the CSI report configuration comprises a CSI report setting associated with all of the CSI report sub-configurations of the plurality of CSI report sub-configurations.
Aspect 52: The method of any of Aspects 21-24, 25-28, and 49-51, wherein the CSI report configuration includes at least one additional reduced antenna port indication associated with at least one additional reduced CSI-RS antenna port configuration.

The foregoing disclosure provides illustration and description but is not intended to be exhaustive or to limit the aspects to the precise forms disclosed. Modifications and variations may be made in light of the above disclosure or may be acquired from practice of the aspects.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A user equipment (UE) for wireless communication, comprising:
one or more memories; and
one or more processors coupled to the one or more memories, the one or more processors individually or collectively configured to:
receive a reduced antenna port indication for spatial element adaptation associated with at least one reduced channel state information reference signal (CSI-RS) antenna port configuration;
receive at least one CSI-RS based on the at least one reduced CSI-RS antenna port configuration; and
compute channel state information (CSI) based on the at least one CSI-RS.

2. The UE of claim 1, wherein the reduced antenna port indication comprises a bitmap indicating, for each antenna port of a plurality of antenna ports of the UE, whether the antenna port is to be used for deriving a CSI-RS resource.

3. The UE of claim 1, wherein the one or more processors, to receive the reduced antenna port indication, are individually or collectively configured to receive a channel state information (CSI) report configuration including the reduced antenna port indication.

4. The UE of claim 3, wherein the CSI report configuration comprises at least one CSI report setting, and wherein the at least one reduced CSI-RS antenna port configuration corresponds to the at least one CSI report setting.

5. The UE of claim 3, wherein the CSI report configuration comprises a plurality of CSI report sub-configurations.

6. The UE of claim 5, wherein the CSI report configuration comprises a CSI report setting associated with all of the CSI report sub-configurations of the plurality of CSI report sub-configurations.

7. The UE of claim 3, wherein the CSI report configuration comprises a plurality of codebook configurations associated with a single CSI-RS resource.

8. The UE of claim 3, wherein the CSI report configuration includes at least one additional reduced antenna port indication associated with at least one additional reduced CSI-RS antenna port configuration.

9. A network node for wireless communication, comprising:
one or more memories; and
one or more processors coupled to the one or more memories, the one or more processors individually or collectively configured to:
transmit a reduced antenna port indication for spatial element adaptation associated with at least one reduced channel state information reference signal (CSI-RS) antenna port configuration; and
transmit at least one CSI-RS based on the at least one reduced CSI-RS antenna port configuration.

10. The network node of claim 9, wherein the reduced antenna port indication comprises a bitmap indicating, for each antenna port of a plurality of antenna ports of a user equipment (UE), whether the antenna port is to be used for deriving a CSI-RS resource.

11. The network node of claim 9, wherein the one or more processors, to transmit the reduced antenna port indication, are individually or collectively configured to transmit a channel state information (CSI) report configuration including the reduced antenna port indication.

12. The network node of claim 11, wherein the CSI report configuration comprises at least one CSI report setting, and wherein the at least one reduced CSI-RS antenna port configuration corresponds to the at least one CSI report setting.

13. The network node of claim 11, wherein the CSI report configuration comprises a plurality of CSI report sub-configurations.

14. The network node of claim 13, wherein the CSI report configuration comprises a CSI report setting associated with all of the CSI report sub-configurations of the plurality of CSI report sub-configurations.

15. The network node of claim 11, wherein the CSI report configuration comprises a plurality of codebook configurations associated with a single CSI-RS resource.

16. The network node of claim 11, wherein the CSI report configuration includes at least one additional reduced antenna port indication associated with at least one additional reduced CSI-RS antenna port configuration.

17. A method of wireless communication performed by a user equipment (UE), comprising:
receiving a reduced antenna port indication for spatial element adaptation associated with at least one reduced channel state information reference signal (CSI-RS) antenna port configuration;
receiving at least one CSI-RS based on the at least one reduced CSI-RS antenna port configuration; and
computing channel state information (CSI) based at least on the at least one CSI-RS.

18. The method of claim 17, wherein the reduced antenna port indication comprises a bitmap indicating, for each antenna port of a plurality of antenna ports of the UE, whether the antenna port is to be used for deriving a CSI-RS resource.

19. The method of claim 17, wherein receiving the reduced antenna port indication comprises receiving a channel state information (CSI) report configuration including the reduced antenna port indication.

20. The method of claim 19, wherein the CSI report configuration comprises at least one CSI report setting, and wherein the at least one reduced CSI-RS antenna port configuration corresponds to the at least one CSI report setting.

21. The method of claim 19, wherein the CSI report configuration comprises a plurality of CSI report sub-configurations.

22. The method of claim 21, wherein the CSI report configuration comprises a CSI report setting associated with all of the CSI report sub-configurations of the plurality of CSI report sub-configurations.

23. The method of claim 19, wherein the CSI report configuration comprises a plurality of codebook configurations associated with a single CSI-RS resource.

24. The method of claim 19, wherein the CSI report configuration includes at least one additional reduced antenna port indication associated with at least one additional reduced CSI-RS antenna port configuration.

25. A method of wireless communication performed by a network node, comprising:
transmitting a reduced antenna port indication for spatial element adaptation associated with at least one reduced channel state information reference signal (CSI-RS) antenna port configuration; and
transmitting at least one CSI-RS based on the at least one reduced CSI-RS antenna port configuration.

26. The method of claim 25, wherein the reduced antenna port indication comprises a bitmap indicating, for each antenna port of a plurality of antenna ports of a user equipment (UE), whether the antenna port is to be used for deriving a CSI-RS resource.

27. The method of claim 25, wherein transmitting the reduced antenna port indication comprises transmitting a channel state information (CSI) report configuration including the reduced antenna port indication.

28. The method of claim 27, wherein the CSI report configuration comprises at least one CSI report setting, and wherein the at least one reduced CSI-RS antenna port configuration corresponds to the at least one CSI report setting.

29. The method of claim 27, wherein the CSI report configuration comprises a plurality of CSI report sub-configurations.

30. The method of claim 29, wherein the CSI report configuration comprises a CSI report setting associated with all of the CSI report sub-configurations of the plurality of CSI report sub-configurations.
